(19) United States
(12) Patent Application Publication
(10) Pub. No.: US 2022/0274342 A1
(43) Pub. Date: Sep. 1, 2022

(54) METHOD FOR MANUFACTURING THREE-DIMENSIONAL SHAPED OBJECT AND THREE-DIMENSIONAL SHAPING APPARATUS

(71) Applicant: SEIKO EPSON CORPORATION, Tokyo (JP)

(72) Inventors: Eiji OKAMOTO, Matsumoto-shi (JP); Akihiko TSUNOYA, Okaya-shi (JP)

(21) Appl. No.: 17/652,313

(22) Filed: Feb. 24, 2022

(30) Foreign Application Priority Data
Feb. 26, 2021 (JP) 2021-029758

(51) Int. Cl. B29C 64/393; B29C 64/118; B29C 64/209; B33Y 10/00; B33Y 30/00; B33Y 50/02; B33Y 70/10

(52) U.S. Cl. CPC B29C 64/393; B29C 64/118; B29C 64/209; B33Y 10/00; B33Y 30/00; B33Y 50/02; B33Y 70/10

(57) ABSTRACT

A method for manufacturing a three-dimensional shaped object is a method for manufacturing a three-dimensional shaped object by laminating a shaping layer. The method includes a selection step of selecting a fiber material corresponding to a thickness of the shaping layer from a plurality of types of fiber materials having different fiber diameters, and a shaping step of forming the shaping layer by discharging a shaping material that includes the fiber material selected in the selection step from a nozzle opening.

The present application is based on, and claims priority from JP Application Serial Number 2021-029758, filed Feb. 26, 2021, the disclosure of which is hereby incorporated by reference herein in its entirety.

### BACKGROUND

### 1. Technical Field

The present disclosure relates to a method for manufacturing a three-dimensional shaped object and a three-dimensional shaping apparatus.

### 2. Related Art

Various manufacturing methods are known in which a shaping material is discharged from a nozzle onto a stage to form shaping layers, and the shaping layers are laminated to shape a three-dimensional shaped object. For example, the following WO15/182675 discloses a technique of discharging a shaping material, in which a fiber material such as a carbon fiber is introduced into a resin material produced by heating and softening a thermoplastic resin such as a filament, to form a shaping layer containing a fiber material inside. According to the technique in WO15/182675, a strength of the three-dimensional shaped object can be enhanced by introducing the fiber material into the shaping material.

When manufacturing the three-dimensional shaped object in which the shaping layers are laminated, shaping may be executed by laminating the shaping layers having different thicknesses. As described above, when introducing fibers into the shaping material, if a fiber diameter of the fiber material to be introduced remains the same for the shaping layers having different thicknesses, there is a possibility that sufficient strength cannot be attained depending on the thicknesses of the shaping layers. Meanwhile, if the fiber materials having different fiber diameters are loaded into a shaping apparatus every time the thickness of the shaping layer to be formed is changed, a loading operation takes time, and there is a possibility that a production efficiency of the three-dimensional shaped object is significantly reduced. As described above, in the technique of shaping the three-dimensional shaped object using the shaping material including the fiber material, there is still room for improvement in achieving both an improvement in the strength of the three-dimensional shaped object and an improvement in the production efficiency.

### SUMMARY

The present disclosure is intended to solve the above-described problems, and can be realized as the following application examples.

A method for manufacturing a three-dimensional shaped object according to an application example of the present disclosure is a method for manufacturing a three-dimensional shaped object by laminating a shaping layer, the method includes: a selection step of selecting a fiber material corresponding to a thickness of the shaping layer from a plurality of types of fiber materials having different fiber diameters; and a shaping step of forming the shaping layer by discharging a shaping material that includes the fiber material selected in the selection step from a nozzle opening.

In a method for manufacturing a three-dimensional shaped object according to another application example of the present disclosure, the plurality of types of fiber materials include a first fiber material and a second fiber material having the fiber diameter larger than that of the first fiber material. In the selection step, the first fiber material is selected when forming a first shaping layer, and the second fiber material is selected when forming a second shaping layer having a thickness larger than that of the first shaping layer.

In a method for manufacturing a three-dimensional shaped object according to another application example of the present disclosure, the shaping step includes: an outline area forming step of forming the shaping layer included in an outline area that forms an outline of the three-dimensional shaped object; and an internal area forming step of forming the shaping layer that is included in an internal area surrounded by the outline area and that has a thickness larger than that of the shaping layer included in the outline area. In the selection step, the first fiber material is selected when forming the shaping layer included in the outline area, and the second fiber material is selected when forming the shaping layer included in the internal area.

In a method for manufacturing a three-dimensional shaped object according to another application example of the present disclosure, a thickness of a single shaping layer included in the internal area corresponds to a sum of the thicknesses of a plurality of the shaping layers that are included and laminated in the outline area.

In a method for manufacturing a three-dimensional shaped object according to another application example of the present disclosure, the shaping step includes: a moving step of relatively moving a stage at which the shaping layer is formed and a nozzle unit having the nozzle opening; and an introduction control step of controlling an introduction speed, at which the fiber material selected in the selection step is introduced toward the nozzle opening, in accordance with a relative movement speed between the nozzle unit and the stage.

In a method for manufacturing a three-dimensional shaped object according to another application example of the present disclosure, the shaping step includes: a plasticizing step of plasticizing at least a part of a material to generate a plasticized material; and a generation step of generating the shaping material to be discharged from the nozzle opening by introducing the fiber material selected in the selection step into the plasticized material. The plasticizing step includes, in a plasticizing apparatus that includes a flat screw that has a groove forming surface in which a groove portion is formed, a facing portion that has a facing surface facing the groove forming surface and that is formed with a communication hole communicating with the nozzle opening, and a heater that is configured to heat the flat screw or the facing portion, a step of supplying the material between the flat screw and the facing portion, and guiding the material to the communication hole while plasticizing at least a part of the material by a rotation of the flat screw and heating of the heater.

In a method for manufacturing a three-dimensional structure according to another application example of the present disclosure, the flat screw has at least one through hole that is opened at the groove forming surface and that communicates with the communication hole. The generation step includes a step of generating the shaping material by introducing the fiber material selected in the selection step into the plasticized material through the through hole.

In a method for manufacturing a three-dimensional shaped object according to another application example of the present disclosure, the groove forming surface or the facing surface has at least one introduction groove that guides the fiber material selected in the selection step from a side of the flat screw or the facing portion to the communication hole. The generation step includes a step of generating the shaping material by introducing the fiber material selected in the selection step into the plasticized material through the introduction groove.

A method for manufacturing a three-dimensional shaped object according to another application example of the present disclosure includes a cutting step of cutting the fiber material by operating a discharge amount control mechanism that is provided upstream of the nozzle opening and that is configured to control a discharge amount of the shaping material.

In a method for manufacturing a three-dimensional shaped object according to another application example of the present disclosure, the discharge amount control mechanism may be driven by a motor. The method includes a step of transmitting a driving force generated by the motor to a conveying unit of the fiber material to convey the fiber material.

A three-dimensional shaping apparatus according to an application example of the present disclosure is a three-dimensional shaping apparatus that manufactures a three-dimensional shaped object by laminating a shaping layer. The three-dimensional shaping apparatus includes a control unit configured to select a fiber material corresponding to a thickness of the shaping layer to be formed from a plurality of types of fiber materials having different fiber diameters, and a discharging unit configured to discharge a shaping material that includes the fiber material selected by the control unit from a nozzle opening under control of the control unit.

### BRIEF DESCRIPTION OF THE DRAWINGS

FIG. 1 is a schematic diagram illustrating a configuration of a three-dimensional shaping apparatus according to a first embodiment.

FIG. 2 is a schematic perspective view illustrating a configuration of a flat screw.

FIG. 3 is a schematic plan view illustrating a configuration of a facing surface of a facing portion.

FIG. 4 is a schematic cross-sectional view illustrating coupling parts between conveying paths and an introduction flow path of fiber materials.

FIG. 5 is a schematic diagram schematically illustrating a step of discharging a shaping material containing a first fiber material.

FIG. 6 is a schematic diagram schematically illustrating a step of discharging a shaping material containing a second fiber material.

FIG. 7 is a schematic diagram schematically illustrating how a three-dimensional shaped object is shaped.

FIG. 8 is a flowchart illustrating steps executed in shaping processing according to the first embodiment.

FIG. 9 is a schematic cross-sectional view of a shaping layer formed by the shaping processing according to the first embodiment.

FIG. 10 is a flowchart illustrating a control procedure of shaping processing according to a second embodiment.

FIG. 11 is a schematic cross-sectional view of a three-dimensional shaped object formed by the shaping processing according to the second embodiment.

FIG. 12 is a schematic diagram illustrating a configuration of a three-dimensional shaping apparatus according to a third embodiment.

FIG. 13 is a schematic cross-sectional view illustrating coupling parts between conveying paths and an introduction flow path of the fiber materials.

FIG. 14 is a schematic cross-sectional view of a three-dimensional shaped object shaped by shaping processing according to the third embodiment.

FIG. 15 is a flowchart illustrating steps executed in shaping processing according to a fourth embodiment.

FIG. 16 is a schematic diagram illustrating a configuration of a three-dimensional shaping apparatus according to a fifth embodiment.

FIG. 17 is a flowchart illustrating steps executed in shaping processing according to the fifth embodiment.

FIG. 18 is a schematic diagram illustrating a configuration of a three-dimensional shaping apparatus according to a sixth embodiment.

FIG. 19 is a schematic plan view illustrating a configuration of a facing surface of a facing portion according to the sixth embodiment.

FIG. 20 is a schematic diagram illustrating a configuration of a three-dimensional shaping apparatus according to a seventh embodiment.

FIG. 21 is a schematic diagram illustrating a configuration of a three-dimensional shaping apparatus according to an eighth embodiment.

FIG. 22 is a schematic diagram illustrating a configuration of a discharge amount control mechanism according to the eighth embodiment.

FIG. 23 is a schematic diagram illustrating a mechanism in which the discharge amount control mechanism cuts a fiber material.

FIG. 24 is a schematic diagram illustrating a configuration of a discharge amount control mechanism according to a ninth embodiment.

FIG. 25 is a schematic diagram illustrating a mechanism in which the discharge amount control mechanism cuts a fiber material.

### DESCRIPTION OF EXEMPLARY EMBODIMENTS

Hereinafter, a method for manufacturing a three-dimensional shaped object and a three-dimensional shaping apparatus according to the present disclosure will be described in detail based on embodiments illustrated in the drawings.

### 1 First Embodiment

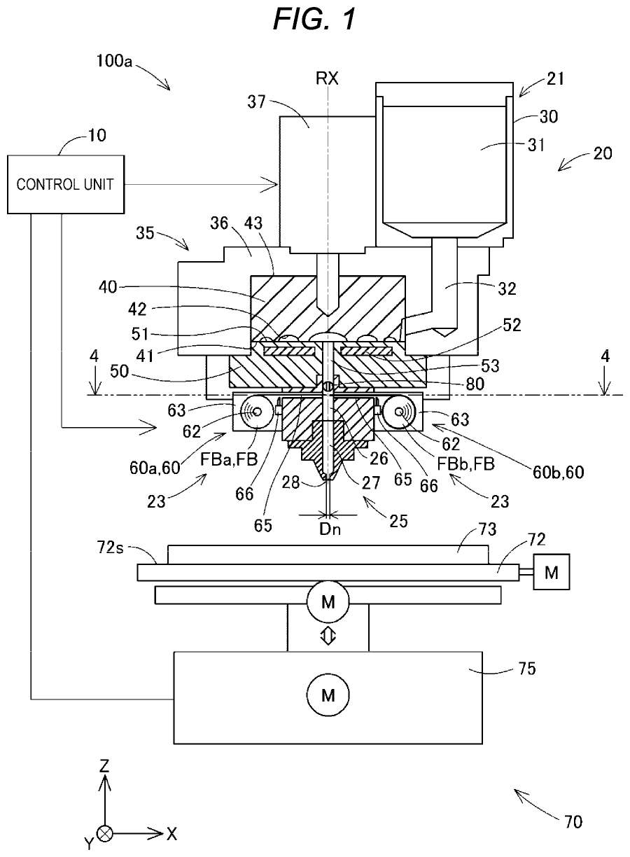

FIG. 1 is a schematic diagram illustrating a configuration of a three-dimensional shaping apparatus 100a that executes a method for manufacturing a three-dimensional shaped object according to a first embodiment. FIG. 1 illustrates arrows indicating X, Y, and Z directions orthogonal to one another. The X direction and the Y direction are directions parallel to a horizontal plane, and the Z direction is a direction opposite to a gravity direction. The arrows indicating the X, Y, and Z directions are also illustrated in other drawings to be referred as necessary so as to correspond to FIG. 1.

The three-dimensional shaping apparatus 100a includes a control unit 10, a discharging unit 20, and a shaping stage unit 70. Under control of the control unit 10, the discharging unit 20 laminates shaping layers formed by discharging a shaping material to the shaping stage unit 70, so that the three-dimensional shaping apparatus 100a manufactures a three-dimensional shaped object. Hereinafter, the “three-dimensional shaped object” is also simply referred to as a “shaped object”, and the “three-dimensional shaping apparatus” is also referred to as a “shaping apparatus”.

The control unit 10 controls an operation of the entire shaping apparatus 100a to execute shaping processing of shaping an object to be shaped. In the first embodiment, the control unit 10 is configured by a computer including one or a plurality of processors (CPUs) and a main storage device (RAM). By the processor executing programs and commands read into the main storage device, the control unit exerts various functions. At least a part of the functions of the control unit 10 may be implemented by a hardware circuit. In the present embodiment, the control unit 10 has a function of executing, in the shaping processing, a selection step of selecting a fiber material FB corresponding to a thickness of the shaping layer from a plurality of fiber materials to be described later. The selection step will be described later.

The discharging unit 20 has a function of discharging, from a nozzle opening under the control of the control unit, the shaping material that includes the fiber material FB selected in the selection step by the control unit 10. The discharging unit 20 includes a material generation unit 21, a fiber introducing unit 23, and a nozzle unit 25. The material generation unit 21 generates a plasticized material included in the shaping material. The plasticized material will be described later. The fiber introducing unit 23 introduces the fiber material FB into the plasticized material formed by the material generation unit 21. The nozzle unit 25 discharges the shaping material including the plasticized material and the fiber material FB. More detailed configurations of the material generation unit 21, the nozzle unit 25, and the fiber introducing unit 23 will be described below in this order.

The material generation unit 21 includes a material supply unit 30 and a plasticizing unit 35. The material supply unit 30 supplies a material that is a raw material of a plasticized material and that contains a thermoplastic resin as a main component to the plasticizing unit 35. Hereinafter, the material supplied to the plasticizing unit 35 is also referred to as a “material for shaping”. In the present embodiment, the material supply unit 30 is configured as a so-called hopper, and includes a material accommodation unit 31 that accommodates a supplied material for shaping, and a communication path 32 that is coupled to a discharge port below the material supply unit and that guides the material for shaping from the material supply unit 30 to the plasticizing unit 35.

The material for shaping is supplied to the material supply unit 30 in a form of a solid material such as pellets or powder. Examples of the thermoplastic resin contained in the material for shaping include, for example, polypropylene resin (PP), polyethylene resin (PE), polyacetal resin (POM), polyvinyl chloride resin (PVC), polyamide resin (PA), acrylonitrile-butadiene-styrene resin (ABS), polylactic acid resin (PLA), polyphenylene sulfide resin (PPS), polyether ether ketone (PEEK), polycarbonate (PC), and the like. In addition to the above-described thermoplastic resin, a pigment, a metal, a ceramic, or the like may be mixed in the material for shaping to be supplied to the material supply unit 30.

The plasticizing unit 35 plasticizes at least a part of the material for shaping supplied from the material supply unit 30 to generate the plasticized material, and sends the plasticized material to the nozzle unit 25. The plasticizing unit 35 can also be referred to as a plasticizing device 35. The plasticizing unit 35 includes a screw case 36, a drive motor 37, a flat screw 40, and a facing portion 50.

The flat screw 40 is a substantially cylindrical screw whose height in an axial direction along a rotation axis RX is smaller than a diameter. The rotation axis RX coincides with a central axis of the flat screw 40. In FIG. 1, the rotation axis RX of the flat screw 40 is illustrated by a dashed line. The flat screw 40 is disposed on the facing portion 50 such that the rotation axis RX is parallel to the Z direction, and rotates in a circumferential direction. A lower surface 41 of the flat screw 40 facing the facing portion 50 has a spiral groove portion 42 extending from a side surface toward the rotation axis RX. Hereinafter, the lower surface 41 of the flat screw 40 is also referred to as a “groove forming surface 41”. The communication path 32 of the material supply unit 30 is coupled to the groove portion 42 at a side surface of the flat screw 40. A specific configuration of the flat screw 40 will be described later.

The flat screw 40 is housed in the screw case 36. An upper surface 43 of the flat screw 40 is coupled to the drive motor 37. The flat screw 40 is rotated in the screw case 36 by a rotational driving force generated by the driving motor 37. The drive motor 37 is driven under the control of the control unit 10.

The facing portion 50 is also referred to as a barrel, and is a substantially cylindrical member whose height in a direction along a central axis is smaller than a diameter thereof. In the present embodiment, the facing portion 50 is disposed such that the central axis thereof coincides with the rotation axis RX of the flat screw 40.

The facing portion 50 has a facing surface 51 facing the groove forming surface 41 of the flat screw 40. A space is formed between the groove portion 42 of the groove forming surface 41 and the facing surface 51 of the facing portion 50. The material for shaping supplied from the material supply unit 30 flows into this space from the side surface of the flat screw 40. The material for shaping supplied to the space in the groove portion 42 is guided to a center of the flat screw 40 by a rotation of the spiral groove portion 42 when the flat screw 40 rotates.

A heater 52 for heating the material for shaping is embedded in the facing surface 51 of the facing portion 50. The heater 52 heats the flat screw 40 or the facing portion 50. In another embodiment, the heater 52 may be embedded in the flat screw 40, or may be disposed separately from the flat screw 40 or the facing portion 50. A communication hole 53, which penetrates the facing portion 50 along a central axis of the facing portion 50, is provided at a center of the facing surface 51. As will be described later, the communication hole 53 communicates with a nozzle opening 28 via an introduction flow path 26 and a nozzle flow path 27 of the nozzle unit 25. The communication hole 53 constitutes a flow path having a substantially circular cross section. While the thermoplastic resin contained in the material for shaping is plasticized and converted into the plasticized material by the heating of the heater 52, the material for shaping supplied to the groove portion 42 of the flat screw 40 is guided to the communication hole 53 opened at the center of the facing surface 51 along the groove portion 42 by a rotation of the flat screw 40. A downstream end of the communication hole 53 is coupled to the nozzle unit 25. The plasticized material generated by the rotation of the flat screw 40 is supplied to the nozzle unit 25 through the communication hole 53.

The nozzle unit 25 includes the introduction flow path 26, the nozzle flow path 27, the nozzle opening 28, and a discharge amount control mechanism 80. The introduction flow path 26 is coupled to the downstream end of the communication hole 53 of the facing portion 50, and is formed linearly from the downstream end of the communication hole 53 along the Z direction. The introduction flow path 26 constitutes a flow path having a substantially circular cross section, and is formed such that a central axis of the introduction flow path coincides with the rotation axis RX of the flat screw 40. In the present embodiment, a diameter of the introduction flow path 26 is substantially equal to a diameter of the communication hole 53 of the facing portion 50.

The nozzle flow path 27 is coupled to a downstream end of the introduction flow path 26, and is formed linearly from the downstream end of the introduction flow path 26 along the Z direction. The nozzle flow path 27 constitutes a flow path having a substantially circular cross section, and is formed such that a central axis of the nozzle flow path coincides with the rotation axis RX of the flat screw 40. The nozzle flow path 27 has a reduced diameter at a downstream end portion thereof. In the present embodiment, the diameter of the nozzle flow path 27 is, except for the downstream end portion thereof, substantially equal to the diameter of the introduction flow path 26. The nozzle opening 28 is an opening having a hole diameter Dn that is formed at the downstream end portion of the nozzle flow path 27 and that opens in the Z direction. The hole diameter Dn of the nozzle opening 28 may be, for example, from 50 μm to 3 mm. In another embodiment, the hole diameter Dn may be smaller than 50 μm or larger than 3 mm. The plasticized material introduced from the material generation unit 21 to the nozzle unit 25 is discharged from the nozzle opening 28 via the introduction flow path 26 and the nozzle flow path 27.

The discharge amount control mechanism 80 is provided in the introduction flow path 26. The discharge amount control mechanism 80 controls a flow rate of the plasticized material in the introduction flow path 26 to control a discharge amount of the shaping material from the nozzle opening 28. In the present embodiment, the discharge amount control mechanism 80 is configured by a butterfly valve that is a valve element that rotates in the introduction flow path 26 under the control of the control unit 10. An opening area of the introduction flow path 26 varies depending on a rotation angle of the butterfly valve. The control unit 10 controls the flow rate of the plasticized material in the introduction flow path 26 by controlling the rotation angle of the valve element. The discharge amount control mechanism 80 can close the introduction flow path 26 so as to stop a flow of the plasticized material in the introduction flow path 26. The discharge amount control mechanism 80 may not be provided in the introduction flow path 26, and may be provided in the nozzle flow path 27. In addition, the discharge amount control mechanism 80 may not be provided in the nozzle unit 25, and may be provided in the communication hole 53 of the facing portion 50, for example.

The fiber material FB, which is to be introduced into the plasticized material by the fiber introducing unit 23, is formed of a fiber bundle in which a plurality of fibers are bundled. In the present embodiment, the fiber material FB has a configuration in which a plurality of carbon fibers are bundled by a sizing agent. In another embodiment, the fiber material FB may not be formed of the carbon fibers, and may be formed of, for example, glass fibers. The fiber material FB may be formed of various fibers having a higher elastic modulus than the resin material.

The fiber introducing unit 23 includes a plurality of types of fiber materials FB that have different fiber diameters and that are to be introduced into the plasticized material. In the present disclosure, the “fiber diameter” of the fiber material corresponds to a dimension of a maximum width in a cross section orthogonal to a length direction of the fiber material. Therefore, for example, when a cross-sectional shape of the fiber material is substantially a circle, the fiber diameter corresponds to a maximum value of a diameter of the circle. When the cross-sectional shape of the fiber material is substantially a quadrangle, the fiber diameter corresponds to the larger one of side lengths of the quadrangle. When the cross-sectional shape of the fiber material is substantially an ellipse, the fiber diameter corresponds to a major axis of the ellipse. In the present embodiment, the fiber material FB is formed of a fiber bundle having a substantially circular cross section.

In the present embodiment, as the plurality of types of fiber materials FB, a first fiber material FBa and a second fiber material FBb that has a fiber diameter larger than that of the first fiber material FBa are loaded in the fiber introducing unit 23. The fiber diameter of the first fiber material FBa may be, for example, from 50 μm to 80 μm, and the fiber diameter of the second fiber material FBb may be, for example, from 80 μm to 200 μm. In the present embodiment, each of the fiber materials FBa and FBb is a single continuous linear member, and is wound around a reel 62. Hereinafter, when it is not necessary to particularly distinguish the first fiber material FBa and the second fiber material FBb, the first fiber material FBa and the second fiber material FBb are referred to as the fiber material FB in the same manner as described above.

The fiber introducing unit 23 includes, as the conveying unit 60 of the fiber material FB, a first conveying unit 60a that conveys the first fiber material FBa and a second conveying unit 60b that conveys the second fiber material FBb. The conveying units 60a and 60b include accommodation units 63 that accommodate the fiber materials FBa and FBb wound around the reels 62, conveying paths 65 that send out the fiber materials FBa and FBb from the accommodation units 63, and cutting units 66 that cut the fiber material FB, respectively.

Each accommodation unit 63 is provided with a conveying motor, which is not illustrated, that generates a conveying force for rotating the reel 62 to send out the fiber material FB through the conveying path 65. A rotation speed of the conveying motor is controlled by the control unit 10. Each conveying path 65 is formed of a cylindrical tubular member through which the fiber material FB is inserted. In the present embodiment, the conveying paths 65 of the first conveying unit 60a and the second conveying unit 60b are coupled to the introduction flow path 26 so that the fiber introducing unit 23 can introduce the fiber material FB into the plasticized material passing through the introduction flow path 26. Each conveying path 65 is coupled to the introduction flow path 26 on downstream of the discharge amount control mechanism 80. A detailed configuration of a coupling part between the conveying path 65 and the introduction flow path 26 will be described later.

The cutting unit 66 is disposed near an entrance of the conveying path 65 in the accommodation unit 63, and cuts the fiber material FB sent to the conveying path 65 under the control of the control unit 10. The cutting unit 66 can be configured by, for example, a mechanism in which a cutter blade protrudes by a solenoid mechanism to cut the fiber material FB. In another embodiment, the cutting unit 66 may be a configuration of cutting the fiber material FB by emitting a laser.

In the present embodiment, under the control of the control unit 10, the fiber introducing unit 23 introduces the fiber material FB selected from the first fiber material FBa and the second fiber material FBb into the plasticized material. The fiber introducing unit 23 sends the fiber material FB selected by the control unit 10 to the introduction flow path 26 through the conveying path 65. The fiber material FB, which is sent out, is sent to the nozzle opening 28 together with the plasticized material flowing through the introduction flow path 26, and is, as the shaping material, discharged from the nozzle opening 28 together with the plasticized material. Shaping of the shaped object by discharging the shaping material will be described later.

The shaping stage unit 70 is disposed at a position at which the shaping stage unit faces the nozzle opening 28 of the discharging unit 20. The shaping stage unit 70 includes a stage 72 that supports the shaped object, a shaping table 73 that is placed on the stage 72, and a moving mechanism 75 that is configured to move the stage 72 in the X, Y, and Z directions. The stage 72 is formed of a plate-shaped member and has a stage surface 72s arranged along a horizontal direction. The shaping table 73 is formed of a plate-shaped member, is placed on the stage surface 72s, and receives the shaping material discharged from the nozzle opening 28. The moving mechanism 75 is configured as a three-axis positioner that moves the stage 72 in three axial directions of the X, Y, and Z directions, and includes three motors M that generate driving forces under the control of the control unit 10. In the shaping processing, the control unit 10 controls the moving mechanism 75 to relatively move the nozzle opening 28 and the stage 72.

In another embodiment, instead of the configuration in which the stage 72 is moved by the moving mechanism 75, a configuration may be adopted in which the moving mechanism 75 moves, in a state in which a position of the stage 72 is fixed, the nozzle opening 28 with respect to the stage 72. Even with such a configuration, the stage 72 and the nozzle opening 28 can be relatively moved. In another embodiment, a configuration may be adopted in which the moving mechanism 75 moves each of the stage 72 and the nozzle opening 28 to change relative positions of the stage 72 and the nozzle opening 28.

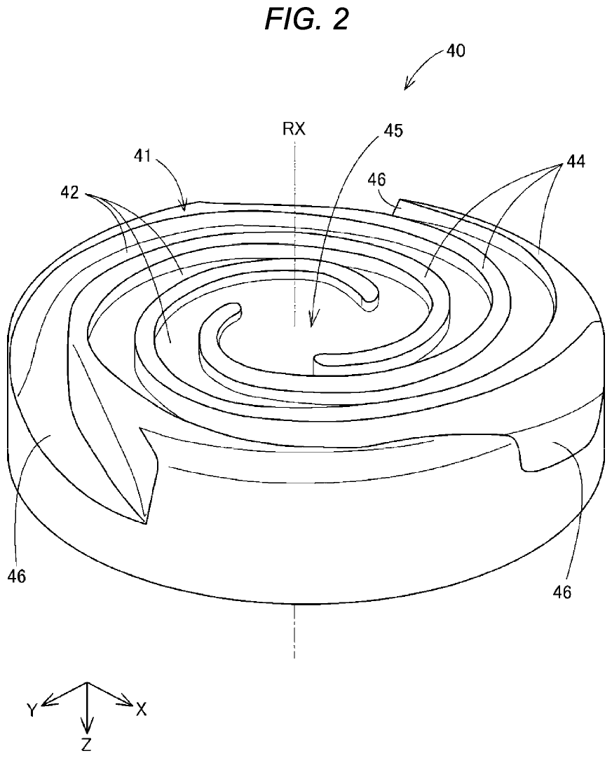

FIG. 2 is a schematic perspective view illustrating the configuration of the flat screw 40 when viewed from the groove forming surface 41 side. In FIG. 2, the rotation axis RX of the flat screw 40 is illustrated by a dashed line. In the present embodiment, the flat screw 40 has a configuration in which three groove portions 42 extend in parallel in a spiral arc toward a central portion of the flat screw 40. The groove portions 42 are respectively defined by three ridge portions 44 extending spirally toward a recessed portion of the central portion 45.

The number of the groove portions 42 of the flat screw 40 may not be three. The flat screw 40 may have only one groove portion 42, or may have two or more groove portions 42. In addition, any number of the ridge portions 44 may be provided in accordance with the number of the groove portions 42. Further, the groove portion 42 may extend in a spiral arc, and may not necessarily extend spirally.

One end of the groove portion 42 is opened at the side surface of the flat screw 40, and constitutes a material inlet 46 that receives the material for shaping supplied from the communication path 32. The groove portion 42 continues to the central portion 45 of the flat screw 40, and the other end of the groove portion 42 is coupled to the central portion 45 of the flat screw 40. The central portion 45 of the flat screw 40 constitutes a recessed portion in which the plasticized material gathers. Here, the plasticized material is formed by plasticizing the thermoplastic resin of the material for shaping.

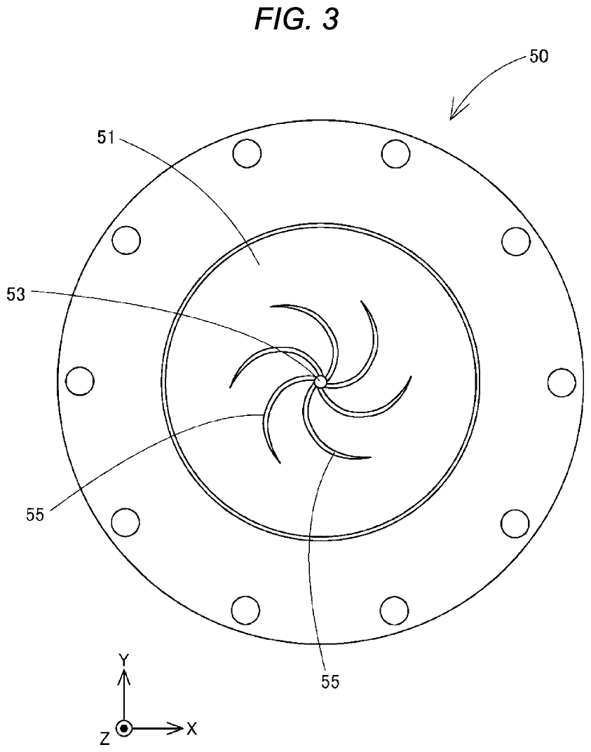

FIG. 3 is a schematic plan view illustrating a configuration of the facing surface 51 of the facing portion 50. As described above, the facing surface 51 faces the groove forming surface 41 of the flat screw 40. At the center of the facing surface 51, the above-described communication hole 53, which is used for supplying the plasticized material flowing into the central portion 45 of the flat screw 40 to the nozzle unit 25, is opened. The facing surface 51 has a plurality of guide grooves 55 that have one end coupled to the communication hole 53, and that extend spirally from the communication hole 53 toward an outer periphery. The guide groove 55 has a function of guiding the plasticized material to the communication hole 53.

The heater 52 illustrated in FIG. 1 is embedded in the facing portion 50. The plasticization of the thermoplastic resin in the plasticizing unit 35 is achieved by the heating of the heater 52 in the facing portion 50 and the rotation of the flat screw 40. According to the shaping apparatus 100a according to the first embodiment, a size of an apparatus configuration for plasticizing the thermoplastic resin can be reduced with the flat screw 40. In addition, according to the shaping apparatus 100a according to the first embodiment, a control of a pressure or the flow rate of the plasticized material to be supplied to the nozzle unit 25 can be facilitated by a rotation control of the flat screw 40. Therefore, accuracy of discharging the shaping material from the nozzle unit 25 can be increased, and accuracy of shaping the shaped object can be increased.

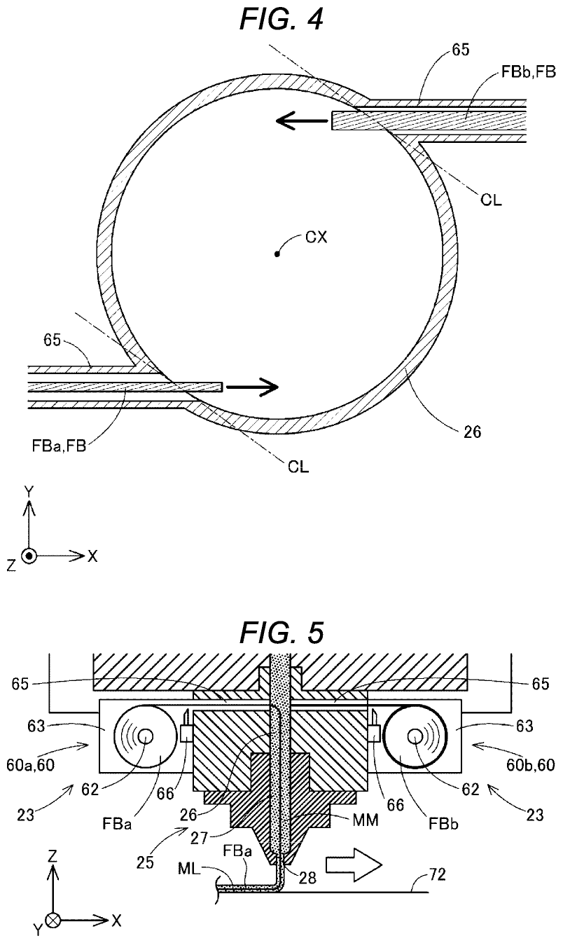

FIG. 4 is a schematic cross-sectional view taken along line 4-4 of FIG. 1, and illustrates coupling parts between the conveying paths 65 of the fiber materials FB and the introduction flow path 26 of the nozzle unit 25. The conveying path 65 of the first fiber material FBa is opened at an internal wall surface of the introduction flow path 26, and the first fiber material FBa is introduced into the introduction flow path 26 through the opening. The conveying path 65 of the second fiber material FBb is also opened at the internal wall surface of the introduction flow path 26, and the second fiber material FBb is introduced into the introduction flow path 26 through the opening. The fiber materials FBa and FBb introduced into the introduction flow path 26 are guided toward the nozzle opening 28 of the nozzle unit 25 by a flow of the plasticized material in the introduction flow path 26.

In the present embodiment, each of the conveying path 65 of the first fiber material FBa and the conveying path 65 of the second fiber material FBb is coupled to the introduction flow path 26 at an acute angle with respect to a tangent line CL of the internal wall surface of the introduction flow path 26, at a coupling position between the conveying path 65 and the introduction flow path 26. Accordingly, when the fiber material FB is started to be introduced, a tip of the fiber material FB is easily guided along the internal wall surface of the introduction flow path 26, so that the fiber materials FBa and FBb are smoothly introduced into the plasticized material. In the present embodiment, the conveying path 65 of the first fiber material FBa and the conveying path 65 of the second fiber material FBb are coupled to the introduction flow path 26 at a position where the conveying path 65 of the first fiber material FBa and the conveying path 65 of the second fiber material FBb face each other with a central axis CX of the introduction flow path 26 interposed therebetween. Accordingly, an interference of introduction paths of the first fiber material FBa and the second fiber material FBb in the introduction flow path 26 is prevented, and thus an occurrence of supply failure due to the interference of the fiber materials FBa and FBb is prevented. In another embodiment, the conveying path 65 of the first fiber material FBa and the conveying path 65 of the second fiber material FBb may be coupled to the introduction flow path 26 at a position where the conveying path 65 of the first fiber material FBa and the conveying path 65 of the second fiber material FBb are offset from each other in the Z direction.

FIG. 5 is a schematic diagram schematically illustrating a step of discharging, from the nozzle opening 28, a shaping material MM that contains the first fiber material FBa introduced by the first conveying unit 60a of the fiber introducing unit 23. In FIG. 5, illustration of the discharge amount control mechanism 80 is omitted for convenience. The first fiber material FBa is introduced into the introduction flow path 26 through the conveying path 65 of the first conveying unit 60a, and is discharged, as the shaping material MM, from the nozzle opening 28 together with the plasticized material flowing through the introduction flow path 26. At this time, the second conveying unit 60b is in a state in which conveying of the second fiber material FBb to the introduction flow path 26 is stopped. When the nozzle opening 28 and the stage 72 are relatively moved in the horizontal direction while discharging the shaping material MM from the nozzle opening 28, the shaping material MM is linearly deposited on the stage 72 so as to draw a movement trajectory, and a shaping layer ML including the first fiber material FBa is formed.

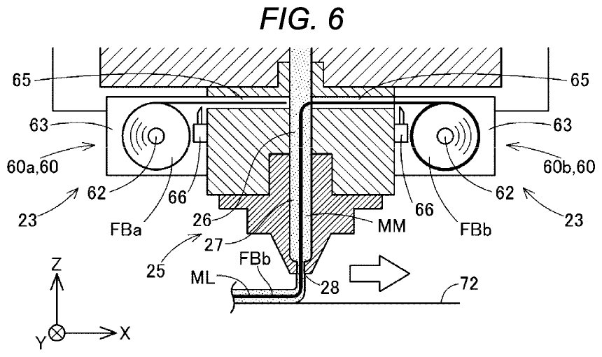

FIG. 6 is a schematic diagram schematically illustrating a step of discharging, from the nozzle opening 28, the shaping material MM that includes the second fiber material FBb introduced by the second conveying unit 60b of the fiber introducing unit 23. In FIG. 6, illustration of the discharge amount control mechanism 80 is omitted for convenience. The second fiber material FBb is introduced into the introduction flow path 26 through the conveying path 65 of the second conveying unit 60b, and is discharged, as the shaping material MM, from the nozzle opening 28 together with the plasticized material flowing through the introduction flow path 26. At this time, the first conveying unit 60a is in a state in which conveying of the first fiber material FBa to the introduction flow path 26 is stopped. When the nozzle opening 28 and the stage 72 are relatively moved in the horizontal direction while discharging the shaping material MM from the nozzle opening 28, the shaping material MM is linearly deposited on the stage 72 so as to draw a movement trajectory, and a shaping layer ML including the second fiber material FBb is formed. As will be described later, a thickness of the shaping layer ML that is formed of the shaping material MM including the second fiber material FBb is different from a thickness of the shaping layer ML that is formed of the shaping material MM, which is illustrated in FIG. 5, including the first fiber material FBa.

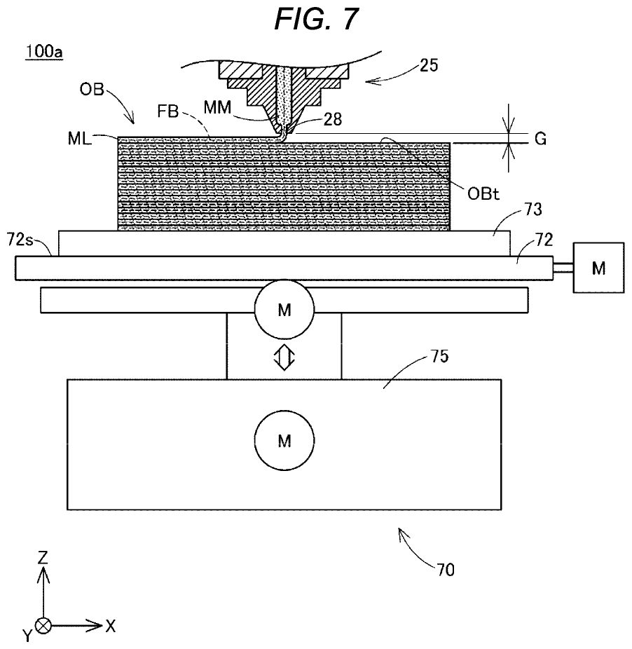

FIG. 7 is a schematic diagram schematically illustrating how the shaping layer ML formed by discharging the shaping material MM from the nozzle opening 28 is laminated, in the shaping apparatus 100a, to shape a shaped object OB. In FIG. 7, the fiber material FB is illustrated by a broken line for convenience. In FIG. 7, the fiber material FB to be introduced into the shaping material MM may be the first fiber material FBa or the second fiber material FBb.

In the shaping apparatus 100a, a gap G is maintained between the nozzle opening 28 and an upper surface OBt of the shaped object OB being shaped. Here, “the upper surface OBt of the shaped object OB” refers to a planned place where the shaping material MM discharged from the nozzle opening 28 is to be deposited near a position directly below the nozzle opening 28. The gap G is adjusted by the moving mechanism 75 changing a relative position between the stage 72 and the nozzle opening 28 in the Z direction.

A size of the gap G is preferably equal to or smaller than the hole diameter Dn of the nozzle opening 28 illustrated in FIG. 1, and more preferably equal to or smaller than 0.8 times the hole diameter Dn. Thus, the shaping material MM discharged from the nozzle opening 28 can be deposited on the upper surface OBt of the shaped object OB, while sufficiently securing a contact surface with the upper surface OBt of the shaped object OB being shaped. As a result, generation of a gap in a cross section of the shaping layer ML and deformation of a shape of an upper surface t of the shaped object OB can be prevented, a strength of the shaped object OB can be secured, and a surface roughness of the shaped object OB can be reduced. In a configuration in which the heater is provided around the nozzle opening 28, by forming the gap G, a decrease in a temperature of the upper surface OBt of the shaped object OB can be appropriately controlled by the heater, and a decrease in adhesion between the laminated shaping layers ML can be prevented. Therefore, an interlayer strength of the shaped object OB can be secured. Further, by forming the gap G, discoloration or deterioration due to overheating of the deposited shaping material MM by the heater can be prevented.

The size of the gap G is preferably 0.5 times or less the hole diameter Dn, and particularly preferably 0.3 times or less the hole diameter Dn. Accordingly, the shaping material MM can be accurately deposited at the planned place. A decrease in adhesion between the shaping material MM and the upper surface OBt, when the shaping material MM is discharged to the upper surface OBt of the shaped object OB, can be prevented, and a decrease in the adhesion between the laminated shaping layers ML can be prevented.

In the present embodiment, the shaping material MM solidifies due to a decrease in a temperature after being discharged from the nozzle opening 28. In another embodiment, the shaping material MM may be a material that is cured by a sintering step of sintering the shaped object OB in a sintering furnace after the shaping of the shaped object OB is completed. Further, the shaping material MM may be a material that is photocured by irradiation with an ultraviolet laser after being discharged from the nozzle opening 28. In this case, the shaping apparatus 100a may include a laser irradiation device for curing the shaping material MM.

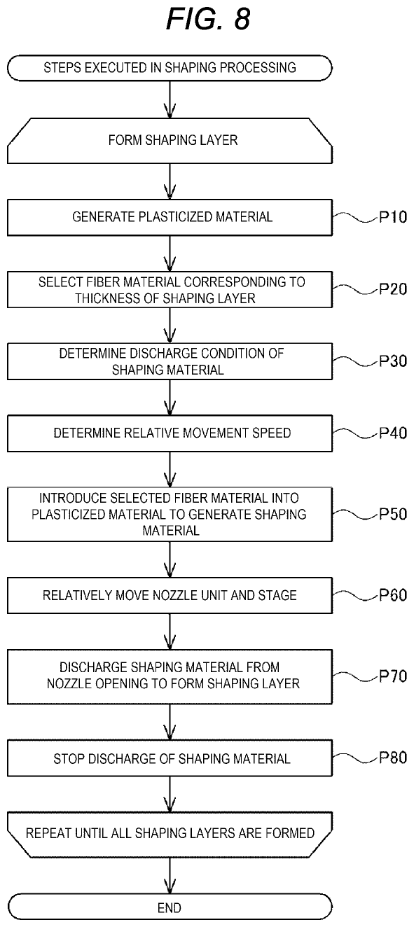

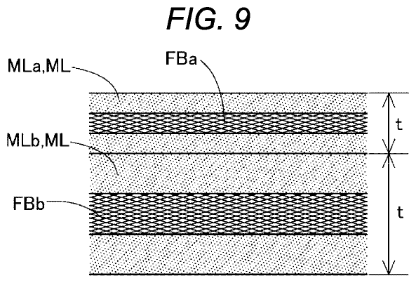

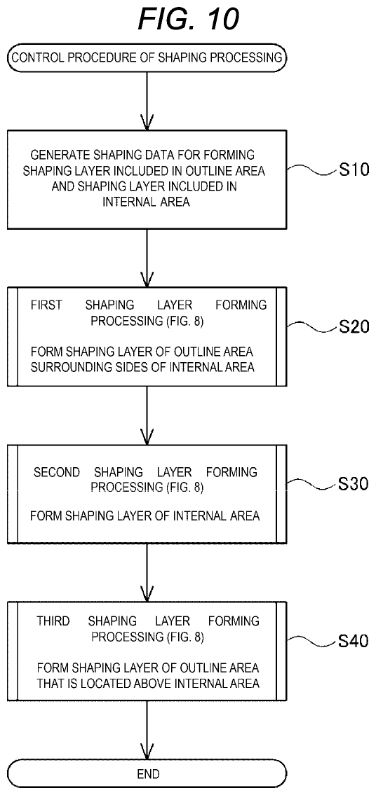

FIG. 8 is a flowchart illustrating steps executed by the shaping apparatus 100a in the shaping processing. This shaping processing is executed based on shaping data for forming the shaping layer ML that constitutes the shaped object OB. The shaping data is generated based on three-dimensional shape data that represent a shape of the shaped object OB, such as three-dimensional CAD data. The shaping data includes, for example, information on a position of the shaping layer ML in the shaped object OB, information on a dimension of the shaping layer ML, information on a movement path of the nozzle opening 28, and the like.

Steps P10 to P80 of the shaping processing correspond to an operation for one pass in the shaping apparatus 100a. The “pass” refers to a processing unit in which the nozzle opening 28 is scanned while continuously discharging the shaping material MM from the nozzle opening 28 without interruption, and one continuous shaping part is formed on the stage 72. One shaping layer ML is formed by executing a series of operations of steps P10 to P80 once or more. In the shaping processing of the present embodiment, steps P10 to P80 are repeated until all the shaping layers ML to be laminated are formed, and the shaping of the shaped object is completed.

Step P10 is a step that is executed by the plasticizing unit 35 of the material generation unit 21 under the control of the control unit 10, and corresponds to a plasticizing step of plasticizing the thermoplastic resin to generate the plasticized material. In the present embodiment, as described above, the thermoplastic resin is plasticized using the flat screw 40. Step P10 includes a step of introducing the material for shaping of the material supply unit 30 into the groove portion 42 of the flat screw 40 while rotating the flat screw 40 in a state in which the flat screw 40 faces the facing portion 50, and guiding at least a part of the thermoplastic resin included in the material for shaping to the communication hole 53 of the facing portion 50 while plasticizing the thermoplastic resin in the groove portion 42. That is, step P10 includes a step of guiding at least a part of the thermoplastic resin that is supplied between the flat screw 40 and the facing portion to the communication hole 53 while plasticizing the thermoplastic resin by the rotation of the flat screw 40 and the heating of the heater 52. As described above, since the flat screw 40 is used in the plasticizing step, a size of the plasticizing unit 35 is reduced. Further, since the control of the pressure and the flow rate of the plasticized material supplied to the nozzle unit 25 is facilitated by the rotation control of the flat screw 40, the accuracy of discharging the shaping material from the nozzle unit 25 can be increased, and the accuracy of shaping the shaped object can be increased. The plasticizing unit 35 continues the plasticizing step in step P10 at least while executing the following steps P20 to P80.

Steps P20 to P40 are steps in which the control unit 10 determines processing conditions in steps P50 to P70. In steps P20 to P40, when a plurality of passes are repeated under the same processing condition to form the same shaping layer ML, some or all of the passes may be omitted as appropriate except for a first pass.

Step P20 corresponds to a selection step in which the control unit 10 selects the fiber material FB corresponding to the thickness of the shaping layer ML to be formed in a current pass from the plurality of types of fiber materials FB having different fiber diameters. As described above, in the present embodiment, the plurality of types of fiber materials FB having different fiber diameters include the first fiber material FBa and the second fiber material FBb, and the shaping apparatus 100a includes the first fiber material FBa and the second fiber material FBb as the plurality of types of fiber materials FB. In step P20 of the present embodiment, the control unit 10 selects the first fiber material FBa having a small fiber diameter when the thickness of the shaping layer ML is smaller than a predetermined threshold value, and selects the second fiber material FBb having a large fiber diameter when the thickness of the shaping layer ML is larger than the predetermined threshold value. That is, in step P20, the first fiber material FBa is selected when forming a first shaping layer ML, and the second fiber material FBb is selected when forming a second shaping layer ML having a thickness larger than that of the first shaping layer. Accordingly, a decrease in strength of the shaping layer ML caused by introducing the fiber material FB having a small fiber diameter into the shaping layer ML having a large thickness can be prevented.

Step P30 corresponds to a step in which the control unit 10 determines an discharge condition when the shaping material MM is to be discharged from the nozzle opening 28 in order to form the shaping layer ML. The discharge condition includes, for example, a discharge amount per unit time of the shaping material MM discharged from the nozzle opening 28 in the current pass. The control unit 10 determines the discharge condition in accordance with the dimension such as the thickness of the shaping layer ML to be formed.

Step P40 corresponds to a step in which the control unit 10 determines a relative movement speed between the nozzle unit 25 and the stage 72 when forming the shaping layer ML. For example, the control unit 10 determines the relative movement speed between the nozzle unit 25 and the stage 72 based on a discharge amount of the shaping material MM that is obtained according to the dimension of the shaping layer ML to be formed and the discharge amount per unit time of the shaping material that is included in the discharge condition determined in the step P30.

Steps P50 to P70 are steps in which a series of operations of the shaping apparatus 100a are performed when the shaping layer ML is formed by discharging the shaping material MM from the nozzle opening 28 while relatively moving the nozzle unit 25 and the stage 72. The shaping apparatus 100a executes step P70 while executing step P50 and the step P60.

Step P50 is a step executed by the fiber introducing unit 23 of the discharging unit 20 under the control of the control unit 10, and corresponds to a generation step of generating the shaping material MM by introducing the fiber material FB selected in step P20 into the plasticized material generated in step P10. In step P20, when the first fiber material FBa is selected, the fiber introducing unit 23 introduces the first fiber material FBa toward the nozzle opening 28 through the conveying path 65. In step P20, when the second fiber material FBb is selected, the fiber introducing unit 23 introduces the second fiber material FBb toward the nozzle opening 28 through the conveying path 65.

Step P60 is a step that is executed by the moving mechanism 75 under the control of the control unit 10, and corresponds to a moving step of relatively moving the stage 72 and the nozzle unit 25. Under the control of the control unit 10, the moving mechanism 75 relatively moves the stage 72 and the nozzle unit 25 at the relative movement speed determined in step P40.

Step P70 is a step that is executed by the discharging unit 20 under the control of the control unit 10, and corresponds to a shaping step of discharging the shaping material MM, into which the selected fiber material FB is introduced, from the nozzle opening 28 to form the shaping layer ML. The discharging unit 20 discharges the shaping material MM from the nozzle opening 28 in the discharge amount per unit time determined in step P30. The control unit 10 controls the discharge amount of the shaping material MM per unit time by controlling the number of rotations of the flat screw 40 and an opening degree of the discharge amount control mechanism 80.

In step P80, the control unit 10 stops discharging the shaping material MM from the nozzle opening 28 at a timing when forming of the shaping layer ML is completed. First, the control unit 10 stops introducing the fiber material FB from the fiber introducing unit 23, and controls the cutting unit 66 to cut the fiber material FB. Thereafter, the control unit 10 controls the discharge amount control mechanism 80 to stop supplying the plasticized material to the nozzle unit 25.

Through the above steps P10 to P80, the shaping layer ML that includes the fiber material FB having the fiber diameter selected according to the thickness of the shaping layer ML is formed. In the shaping processing, steps P10 to P80 described above are repeated, and the shaped object is shaped by laminating the shaping layer ML including the fiber material FB.

FIG. 9 is a schematic cross-sectional view that schematically illustrates a cross section along a laminating direction in an example of the shaping layer ML to be formed by the shaping processing. As described above, according to the shaping processing of the present embodiment, the first fiber material FBa having a small fiber diameter is introduced into a first shaping layer MLa having a small thickness t, and the second fiber material FBb having a large fiber diameter is introduced into a second shaping layer MLb having a large thickness t. Since the second fiber material FBb having a large fiber diameter is used for the second shaping layer MLb having the large thickness t, a strength of the second shaping layer MLb having the large thickness t can be enhanced as compared with a case in which the same first fiber material FBa as that of the first shaping layer MLa having the small thickness t is introduced into the second shaping layer MLb having the large thickness t.

As described above, according to the method for manufacturing the three-dimensional shaped object that is achieved in the shaping processing according to the first embodiment, the control unit 10 selects the fiber material FB to be used for forming the shaping layer ML from the plurality of types of fiber materials FB according to the thickness of the shaping layer ML. Under the control of the control unit 10, the fiber introducing unit 23 introduces the selected fiber material FB into the shaping material MM. According to this manufacturing method, the fiber material FB having an appropriate fiber diameter corresponding to the thickness of the shaping layer ML can be selected and introduced from the plurality of types of fiber materials FB under the control of the control unit 10. Therefore, the strength of the shaped object OB can be enhanced by introducing the fiber material FB having the appropriate fiber diameter, and a decrease in productivity of the shaped object OB due to times and efforts required for replacing the fiber materials FB having different fiber diameters can be prevented.

### 2 Second Embodiment

FIG. 10 is a flowchart illustrating a control procedure that is executed by the control unit 10 in a shaping processing according to the second embodiment. FIG. is a schematic cross-sectional view schematically illustrating a cross section along a laminating direction of an example of a shaped object OBa formed by the shaping processing according to the second embodiment. The shaping processing according to the second embodiment is executed by the shaping apparatus 100a illustrated in FIG. 1 described in the first embodiment.

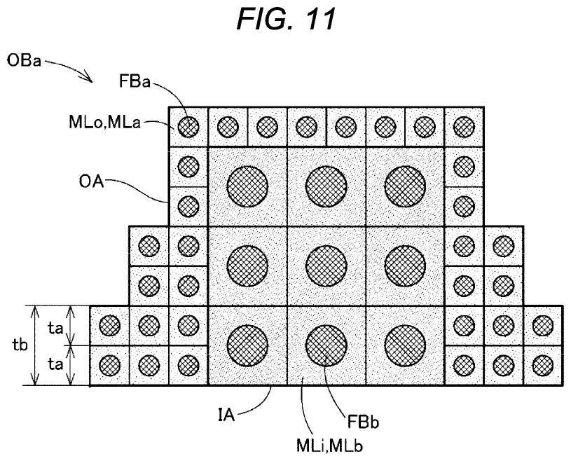

In the shaping processing according to the second embodiment, an outline area OA constituting an outline of the shaped object OBa and an internal area IA surrounded by the outline area OA are shaped by shaping layers MLo and MLi having different thicknesses. In FIG. 11, for convenience, the shaping layer MLo included in the outline area OA and the shaping layer MLi included in the internal area IA are hatched differently.

In step S10, the control unit 10 generates shaping data, which is for forming the shaping layer MLo included in the outline area OA of the shaped object OBa and the shaping layer MLi included in the internal area IA, based on three-dimensional shape data representing a shape of the shaped object OBa. First, based on the three-dimensional shape data, the control unit 10 divides the shaped object OBa into the outline area OA constituting the outline and the internal area IA constituting an internal structure. Subsequently, the control unit 10 respectively decomposes the outline area OA and the internal area IA into the shaping layers MLo and MLi, and generates the shaping data. At this time, the control unit 10 generates the shaping data such that a thickness of the shaping layer MLo included in the outline area OA is smaller than a thickness of the shaping layer MLi included in the internal area IA.

In step S20, the control unit 10 executes a first shaping layer forming processing for forming the shaping layer MLo included in the outline area OA surrounding sides of the internal area IA. In the first shaping layer forming processing, the shaping apparatus 100a repeatedly executes steps P10 to P80, which are similar to the steps of the shaping processing in FIG. 8 described in the first embodiment, until all the shaping layers MLo that are included in the outline area OA and that are located on the sides of the internal area IA to be shaped are formed. In a selection step in step P20 in the first shaping layer forming processing, the first fiber material FBa is selected. That is, the shaping layer MLo included in the outline area OA corresponds to the first shaping layer MLa.

In step S30, the control unit 10 executes a second shaping layer forming processing for forming the shaping layer MLi included in the internal area IA. In the second shaping layer forming processing, the shaping apparatus 100a repeatedly executes steps P10 to P80, which are similar to the steps of the shaping processing in FIG. 8 described in the first embodiment, until all the shaping layers MLi included in the internal area IA to be shaped are formed. In the selection step of step P20 in the second shaping layer forming processing, the second fiber material FBb is selected for the shaping layer MLi. That is, the shaping layer MLi included in the internal area IA corresponds to the second shaping layer MLb.

In step S40, the control unit 10 executes a third shaping layer forming processing for forming the shaping layer MLo that is included in the outline area OA and that is located above the internal area IA. In the third shaping layer forming processing, similarly to the first shaping layer forming processing in step S20, the shaping layer MLo into which the first fiber material FBa is introduced is formed as the selected fiber material FB. In the third shaping layer forming processing, the shaping apparatus 100a repeatedly executes steps P10 to P80, which are similar to the steps of the shaping processing of FIG. 8 described in the first embodiment, until all the shaping layers MLo, which are included in the outline area OA located above the internal area IA to be shaped, are formed.

Here, a shaping step in step P70 in the first shaping layer forming processing corresponds to an outline area forming step of forming the shaping layer MLo included in the outline area OA. The shaping step in step P70 in the second shaping layer forming processing corresponds to an internal area forming step of forming the shaping layer MLi that is included in the internal area IA and that has a larger thickness than that of the shaping layer MLo included in the outline area OA. In the shaping processing according to the second embodiment, in the selection step in step P20 in the first shaping layer forming processing and the second shaping layer forming processing, the first fiber material FBa is selected when forming the shaping layer MLo included in the outline area OA, and the second fiber material FBb is selected when forming the shaping layer MLi included in the internal area IA.

According to the shaping processing according to the second embodiment, the outline of the shaped object OBa can be more finely shaped by the shaping layer MLo having a small thickness. Since the thickness of the shaping layer MLi in the internal area IA is large, the internal area IA that does not appear in an appearance can be formed more efficiently in a short time. According to the shaping processing according to the second embodiment, the fiber materials FB having appropriate fiber diameters are respectively introduced into the shaping layers MLo and MLi having different thicknesses, so that a difference in strength between the outline area OA and the internal area IA of the shaped object OBa due to a difference in thickness between the shaping layers MLo and MLi is prevented from increasing.

In the shaping processing according to the second embodiment, the shaping is executed such that a thickness tb of the shaping layer MLi included in the internal area IA corresponds to a sum of thicknesses ta of a plurality of laminated shaping layers MLo included in the outline area OA. FIG. 11 illustrates an example in which the shaping is executed such that the thickness tb of the shaping layer MLi corresponds to a sum of thicknesses ta of two shaping layers MLo. Accordingly, the internal structure can be formed in a short time while forming the outline more precisely. The shaping may be executed such that the thickness tb of the shaping layer MLi included in the internal area IA corresponds to a sum of thicknesses ta of two or more shaping layers MLo included in the outline area OA.

As described above, according to a shaping method achieved by the shaping processing according to the second embodiment, a strength of the shaped object OBa can be enhanced by respectively introducing the fiber materials FB having appropriate fiber diameters into the respective shaping layers MLo and MLi. A formation time of the internal structure of the shaped object can be shortened while finely shaping the outline, and productivity of the shaped object OBa can be further improved.

### 3 Third Embodiment

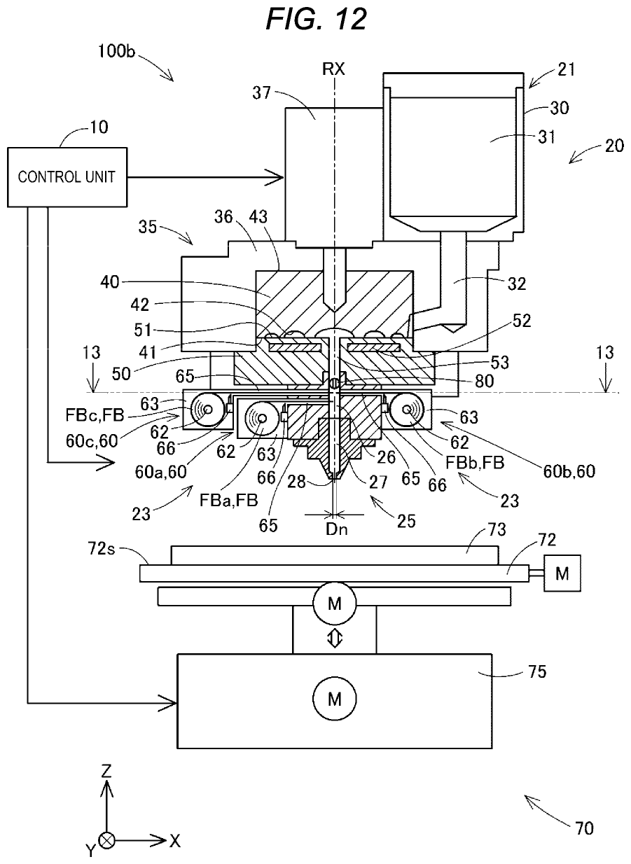

FIG. 12 is a schematic diagram illustrating a configuration of a shaping apparatus 100b according to a third embodiment. The shaping apparatus 100b according to the third embodiment has substantially the same configuration as the shaping apparatus 100a according to the first embodiment except that the fiber introducing unit 23 includes, in addition to the first conveying unit 60a and the second conveying unit 60b, a third conveying unit 60c that introduces a third fiber material FBc.

The shaping apparatus 100b includes, in addition to the first fiber material FBa and the second fiber material FBb, the third fiber material FBc as the plurality of types of fiber materials FB having different fiber diameters. A fiber diameter of the third fiber material FBc is larger than the fiber diameter of the first fiber material FBa and smaller than the fiber diameter of the second fiber material FBb. Similarly to the first fiber material FBa and the second fiber material FBb, the third fiber material FBc is accommodated in the accommodation unit including the third conveying unit 60c in a state of being wound around the reel 62, and is sent out from the accommodation unit 63 to the introduction flow path 26 through the conveying path 65 of the third conveying unit 60c. In FIG. 12, for convenience, the third conveying unit 60c is illustrated above the accommodation unit 63 and the conveying path 65 of the first conveying unit 60a, but in practice, the third conveying unit 60c is disposed at substantially the same height position as the first conveying unit 60a and the second conveying unit 60b. The “height position” refers to a position in the Z direction.

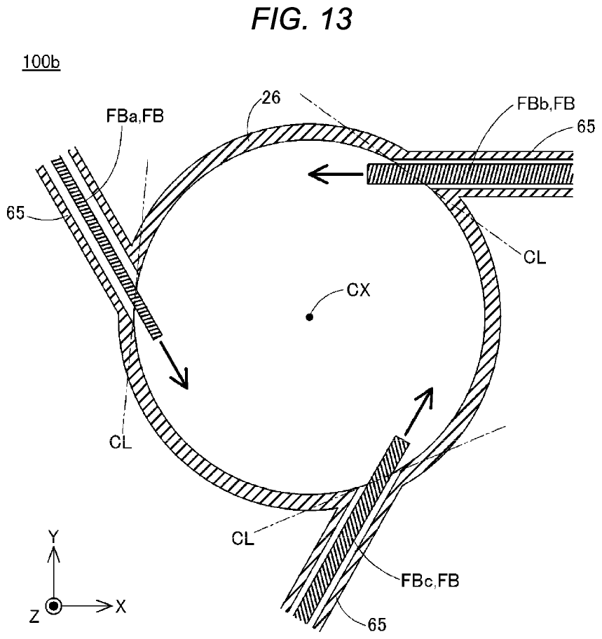

FIG. 13 is a schematic cross-sectional view taken along line 13-13 illustrated in FIG. 12, and illustrates coupling parts between the conveying paths 65 of the fiber materials FB and the introduction flow path 26 of the nozzle unit 25. In the shaping apparatus 100b, positions in the Z direction of the coupling parts between the conveying paths 65 for respectively sending out the three fiber materials FBa, FBb, and FBc and the introduction flow path 26 are the same. Openings of the conveying paths 65 in the introduction flow path 26, which serve as outlets of the conveying paths 65, are arranged at substantially equal intervals in a circumferential direction of the introduction flow path 26. Each conveying path 65 is coupled at an acute angle with respect to the tangent line CL of the internal wall surface of the introduction flow path 26 at a coupling position between the conveying path 65 and the introduction flow path 26. The openings of the respective conveying paths 65 in the introduction flow path 26 are opened in the same direction in the circumferential direction around the central axis of the introduction flow path 26. Accordingly, introduction paths of the three fiber materials FBa, FBb, and FBc are prevented from interfering with one another in the introduction flow path 26.

In another embodiment, the coupling parts of the conveying paths 65 of the fiber materials FBa, FBb, and FBc may be different in the Z direction, and an opening direction of the outlet of each conveying path 65 in the introduction flow path 26 is not limited to the above-described direction. The conveying paths 65 may be coupled to a flow path of a plasticized material other than the introduction flow path 26.

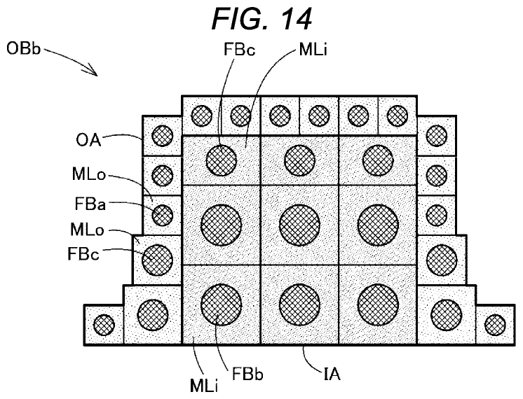

FIG. 14 is a schematic cross-sectional view schematically illustrating a cross section along a laminating direction of an example of a shaped object OBb shaped by a shaping processing of the shaping apparatus 100b according to the third embodiment. In FIG. 14, for convenience, the shaping layer MLo included in the outline area OA and the second shaping layer MLi included in the internal area IA are illustrated with different types of hatching.

In the shaping apparatus 100b according to the third embodiment, the control unit 10 executes the shaping processing according to a control procedure illustrated in FIG. 10. However, in the shaping processing according to the third embodiment, in step S10, the control unit 10 sets a plurality of different thicknesses as the thickness of the shaping layer MLo included in the outline area OA, and sets a plurality of different thicknesses as the thickness of the shaping layer MLi included in the internal area IA. A minimum value of the thickness of the shaping layer MLo included in the outline area OA is smaller than a minimum value of the thickness of the shaping layer MLi included in the internal area IA.

In the first shaping layer forming processing in step S20 and the third shaping layer forming processing in step S40, the control unit 10 selects, in the selection step of step P20, the first fiber material FBa when the thickness of the shaping layer MLo in the outline area OA is smaller than a predetermined threshold. The control unit 10 selects the third fiber material FBc when the thickness of the shaping layer MLo in the outline area OA is larger than the threshold value. In the second shaping layer forming processing in step S30, the control unit 10 selects, in the selection step in step P20, the second fiber material FBb when the thickness of the shaping layer MLi in the internal area IA is larger than a predetermined threshold value. The control unit 10 selects the third fiber material FBc when the thickness of the shaping layer MLi in the internal area IA is larger than the threshold value.

According to the shaping processing according to the third embodiment, a shaping layer including the first fiber material FBa and a shaping layer including the third fiber material FBc are formed as the shaping layer MLo in the outline area OA, and a shaping layer including the second fiber material FBb and a shaping layer including the third fiber material FBc are formed as the shaping layer MLi in the internal area IA.

In the third embodiment, similarly to the second embodiment, the shaping processing in step P70 in the first shaping layer forming processing corresponds to the outline area forming step, and the shaping processing in step P70 in the second shaping layer forming processing corresponds to the internal area forming step. The shaping processing according to the third embodiment can be interpreted as including a step of selecting the first fiber material FBa when forming the shaping layer MLo included in the outline area OA and a step of selecting the second fiber material FBb when forming the shaping layer MLi included in the internal area IA.

As described above, according to the shaping apparatus 100b according to the third embodiment, appropriate fiber materials FB are selected and introduced from the three types of fiber materials FBa, FBb, and FBc having different fiber diameters according to the thickness of the shaping layer ML. Accordingly, a range of selecting the fiber diameters of the fiber materials FB is wide, and a large difference in the strength of the shaping layer ML due to a difference in the thickness of the shaping layer ML can be further prevented. Under the control of the control unit 10, the fiber introducing unit 23 switches the three types of fiber materials FBa, FBb, and FBc and introduces the fiber materials FBa, FBb, and FBc into the shaping material, so that the productivity of the shaped object OBb can be further improved.

### 4 Fourth Embodiment

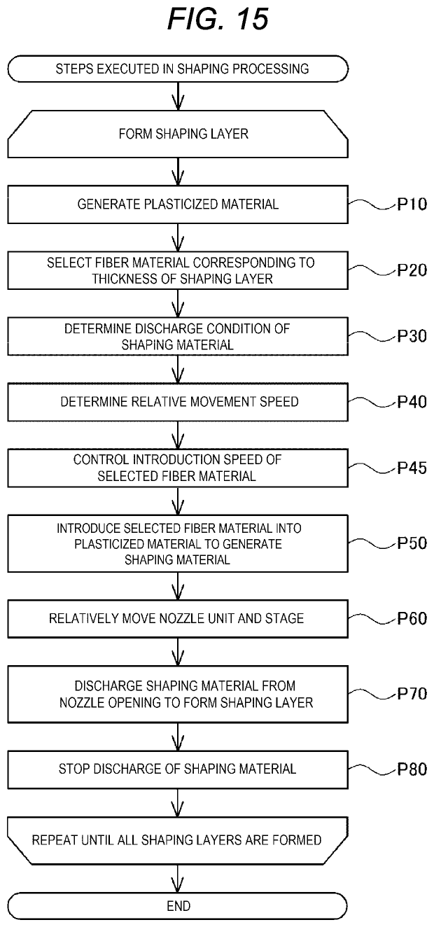

FIG. 15 is a flowchart illustrating steps executed in a shaping processing according to a fourth embodiment. The flowchart in FIG. 15 is substantially the same as the flowchart in FIG. 8 described in the first embodiment except that step P45 is added. The shaping processing according to the fourth embodiment is executed by the shaping apparatus 100a illustrated in FIG. 1 described in the first embodiment.

Step P45 is executed after steps P10 to P40. Step P45 corresponds to an introduction control step in which the control unit 10 controls an introduction speed, at which the fiber material FB selected in step P20 is introduced into the nozzle opening 28, in accordance with the relative movement speed between the nozzle unit 25 and the stage 72 determined in step P40. The “introduction speed” corresponds to a length of the fiber material FB to be send from the conveying path 65 per unit time. In the fourth embodiment, the control unit 10 sets a target value of the introduction speed of the fiber material FB to be larger as the relative movement speed between the nozzle unit 25 and the stage 72 is larger, and controls a rotation speed of the reel 62 around which the fiber material FB is wound according to the target value of the introduction speed.

Thus, since the introduction speed of the fiber material FB is controlled according to the relative movement speed between the nozzle unit 25 and the stage 72, it is possible to prevent a change in an amount or a state of the fiber material FB to be introduced into the shaping layer ML due to a change in the relative movement speed between the nozzle opening 28 and the stage 72. Since the introduction speed of the fiber material FB is controlled to be larger as the relative movement speed between the nozzle opening 28 and the stage 72 is larger, the introduction of the fiber material FB into the shaping material MM can be prevented from failing to catch up with a forming speed of the shaping layer ML.

### 5 Fifth Embodiment

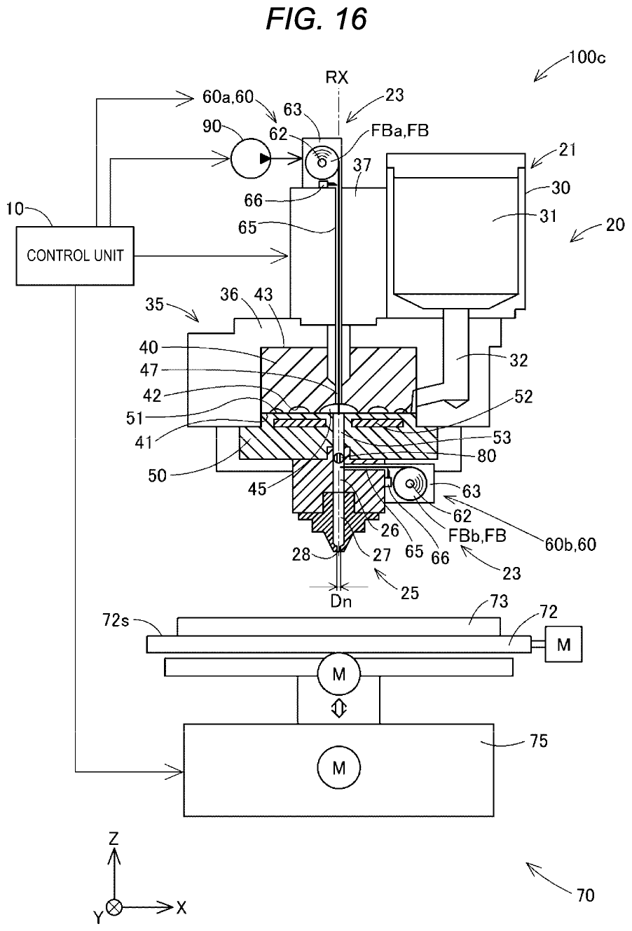

FIG. 16 is a schematic diagram illustrating a configuration of a shaping apparatus 100c according to a fifth embodiment. The shaping apparatus 100c according to the fifth embodiment has substantially the same configuration as the shaping apparatus 100a according to the first embodiment illustrated in FIG. 1 except that the flat screw 40 has a through hole 47, that the first conveying unit 60a is provided above the plasticizing unit 35, and that a pressure control unit 90 is added.

In the fifth embodiment, the flat screw 40 has the through hole 47 that penetrates from the upper surface 43 to the central portion 45 of the groove forming surface 41 at a position through which the rotation axis RX passes. The first conveying unit 60a is provided on the plasticizing unit 35. The accommodation unit 63 of the first conveying unit 60a is disposed on the drive motor 37 of the flat screw 40. The conveying path 65 of the first conveying unit 60a is coupled to the through hole 47 of the flat screw 40 through a drive shaft of the drive motor 37. Thus, in the selection step, when the first fiber material FBa is selected, the first fiber material FBa is introduced into the plasticized material through the through hole 47 of the flat screw 40. In another embodiment, instead of the first conveying unit 60a, the second conveying unit 60b may be provided on the plasticizing unit 35, and in the selection step, when the second fiber material FBb is selected, the second fiber material FBb may be introduced into the plasticized material through the through hole 47 of the flat screw 40.

The pressure control unit 90 includes a pump. The pressure control unit 90 is coupled to the accommodation unit 63 of the first conveying unit 60a, and controls a pressure in the through hole 47 of the flat screw 40 through the accommodation unit 63 of the first conveying unit 60a and the conveying path 65 under the control of the control unit 10.

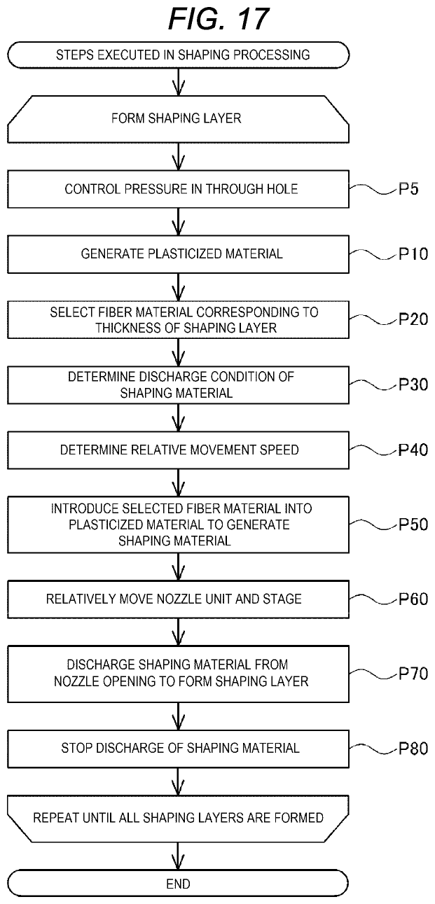

FIG. 17 is a flowchart illustrating steps executed by the shaping apparatus 100c in the shaping processing according to the fifth embodiment. The flowchart in FIG. is substantially the same as the flowchart in FIG. 8 described in the first embodiment except that step P5 is added. Step P5 corresponds to a pressure control step in which the control unit 10 controls the pressure control unit 90 to control the pressure in the through hole 47 of the flat screw 40 to be higher than a pressure in the communication hole 53 of the facing portion 50. The pressure in the communication hole 53 is controlled by the control unit 10 controlling the number of rotations of the flat screw 40. Step P5 is started before the generation of the plasticized material in step P10, and is continued during the generation of the plasticized material in the plasticizing unit 35.

According to the shaping apparatus 100c according to the fifth embodiment, the first fiber material FBa can be smoothly introduced into the communication hole 53 of the facing portion 50 through the through hole 47 of the flat screw 40. Since the pressure in the through hole 47 of the flat screw 40 is controlled to be higher than the pressure in the communication hole 53 of the facing portion 50 by the pressure control unit 90, the plasticized material of the central portion 45 can be prevented from flowing into the through hole 47.

### 6 Sixth Embodiment

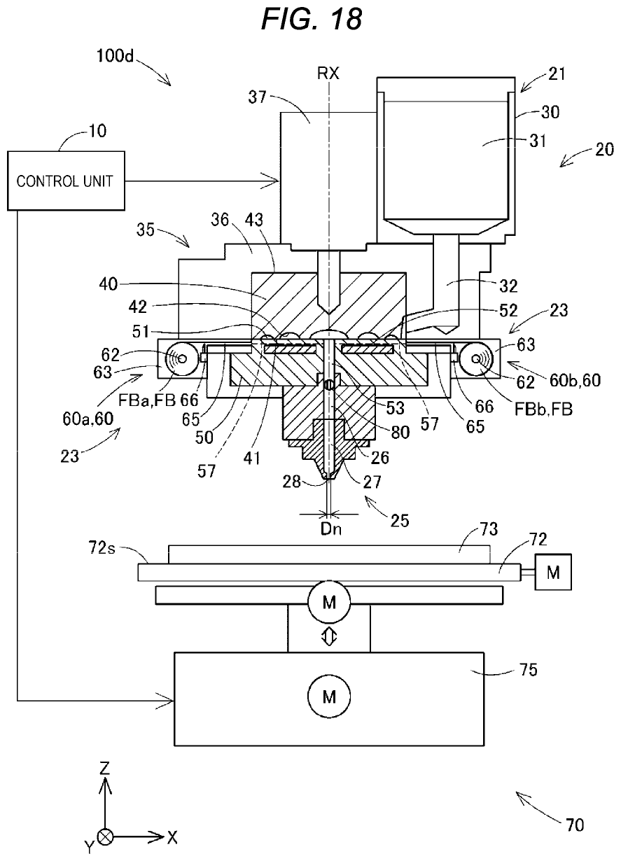

FIG. 18 is a schematic diagram illustrating a configuration of a shaping apparatus 100d according to a sixth embodiment. The shaping apparatus 100d according to the sixth embodiment has substantially the same configuration as the shaping apparatus 100a according to the first embodiment except for the following matters. In the shaping apparatus 100d, the facing surface 51 of the facing portion 50 has introduction grooves 57, and each conveying path 65 of the first conveying unit 60a and the second conveying unit 60b is coupled to the introduction groove 57 instead of the introduction flow path 26 of the nozzle unit 25. In FIG. 18, the introduction grooves 57 are illustrated by broken lines for convenience.

FIG. 19 is a schematic plan view illustrating a configuration of the facing surface 51 of the facing portion 50 according to the sixth embodiment. The facing surface 51 has two introduction grooves 57 for introducing the fiber material FB, in addition to a plurality of guide grooves 55 for guiding the plasticized material to the communication hole 53 at the center of the facing surface 51. The introduction groove 57 is formed to avoid interference with the guide groove 55 from an outer peripheral end of the facing surface 51 to the communication hole 53. One introduction groove 57 is coupled to the conveying path 65 of the first conveying unit 60a, and the other introduction groove 57 is coupled to the conveying path 65 of the second conveying unit 60b. Accordingly, the first fiber material FBa and the second fiber material FBb can be guided to the communication hole 53 from a side position of the flat screw 40, which is a side position of the facing portion 50.

In a shaping processing of the shaping apparatus 100d, the steps illustrated in FIG. 8 described in the first embodiment are executed. In the generation step in step P50, the fiber material FB selected in step P20 is introduced through the introduction groove 57 to generate the shaping material MM. According to this configuration, the shaping material MM can be efficiently generated by guiding the fiber material FB to the communication hole 53 using a rotational force of the flat screw 40 and introducing the fiber material FB into the plasticized material.

### 7 Seventh Embodiment

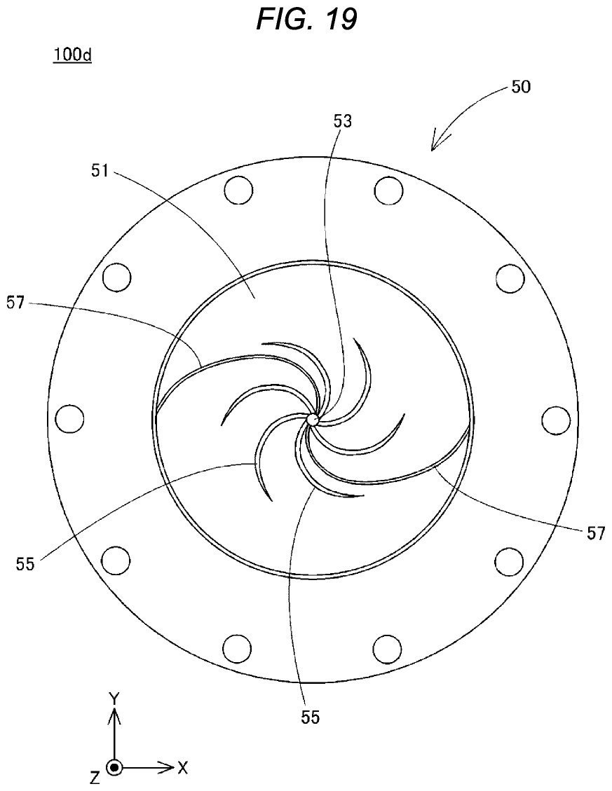

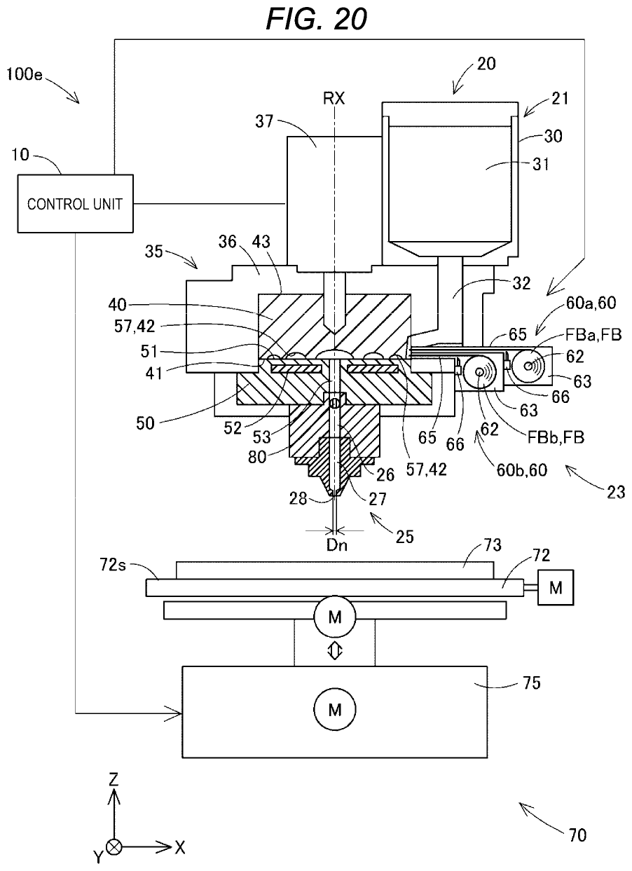

FIG. 20 is a schematic diagram illustrating a configuration of a shaping apparatus 100e according to a seventh embodiment. The shaping apparatus 100e according to the seventh embodiment has substantially the same configuration as the shaping apparatus 100a according to the first embodiment except for the following matters. In the shaping apparatus 100e, the conveying paths 65 of the first conveying unit 60a and the second conveying unit 60b are inserted into the screw case 36, and are configured to be coupled to the groove portion 42 from a side of the flat screw 40. In the seventh embodiment, the groove portion 42 of the flat screw 40 is configured as the introduction groove 57 that guides the fiber material FB from the side of the flat screw 40 or a side of the facing portion 50 to the communication hole 53. According to the shaping apparatus 100e according to the seventh embodiment, similarly to the shaping apparatus 100d according to the sixth embodiment, the shaping material can be efficiently generated by guiding the fiber material FB to the communication hole 53 through the introduction groove 57 using the rotational force of the flat screw 40 and introducing the fiber material FB into the plasticized material.

### 8 Eighth Embodiment

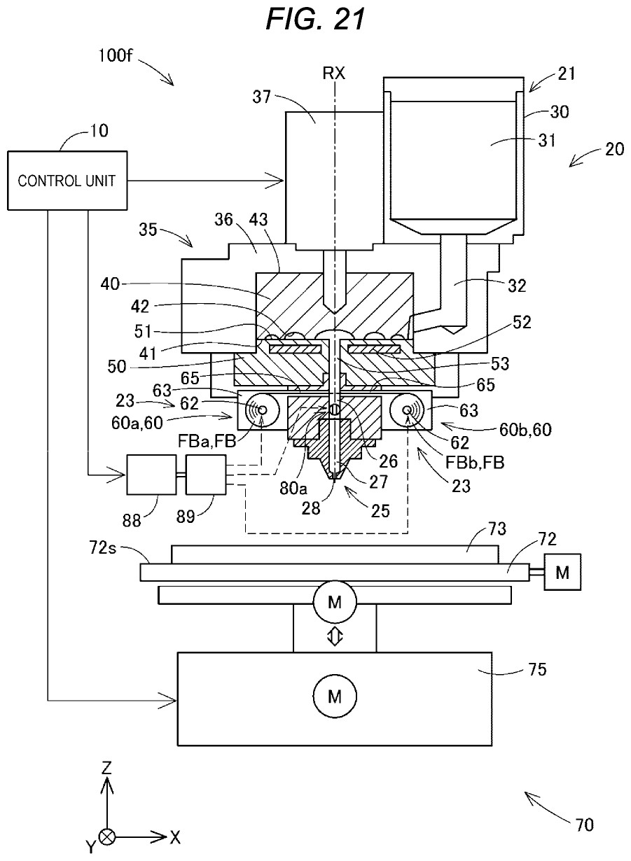

FIG. 21 is a schematic diagram illustrating a configuration of a shaping apparatus 100f according to an eighth embodiment. The shaping apparatus 100f according to the eighth embodiment has substantially the same configuration as the shaping apparatus 100a according to the first embodiment except for the following matters. In the shaping apparatus 100f, the cutting unit 66 of the accommodation unit 63 of each of the conveying units 60a and 60b is omitted. The shaping apparatus 100f includes a discharge amount control mechanism 80a that is provided upstream of the nozzle opening 28 and that controls the discharge amount of the shaping material from the nozzle opening 28. The discharge amount control mechanism 80a according to the eighth embodiment has a function as a cutting unit that cuts the fiber material FB, as will be described later. The shaping apparatus 100f includes a motor 88 that generates a driving force, and a gear unit 89 that switches a transmission destination of the driving force of the motor 88 to the discharge amount control mechanism 80a or the conveying units 60a and 60b. The motor 88 is, for example, a stepping motor. The switching of the transmission destination of the driving force of the motor 88 by the control unit 10 will be described later.

FIG. 22 is a schematic diagram illustrating the configuration of the discharge amount control mechanism 80a according to the eighth embodiment. FIG. 22 schematically illustrates a state in which the discharge amount control mechanism 80a opens a flow path and the fiber material FB passes through the opened flow path. The discharge amount control mechanism 80a includes a butterfly valve 81, which is a valve element that rotates in the introduction flow path 26, and a cutter blade 82 provided around the butterfly valve 81. The butterfly valve 81 is provided downstream of the coupling part between the conveying path 65 of the fiber introducing unit 23 and the introduction flow path 26. The butterfly valve 81 is rotated by the driving force of the motor 88, and changes the opening area of the introduction flow path 26 according to a rotation angle of the butterfly valve 81. The control unit 10 controls the discharge amount of the shaping material from the nozzle opening 28 based on the rotation angle of the butterfly valve 81. The cutter blade 82 is provided at a position close to a rotation area of the butterfly valve 81.

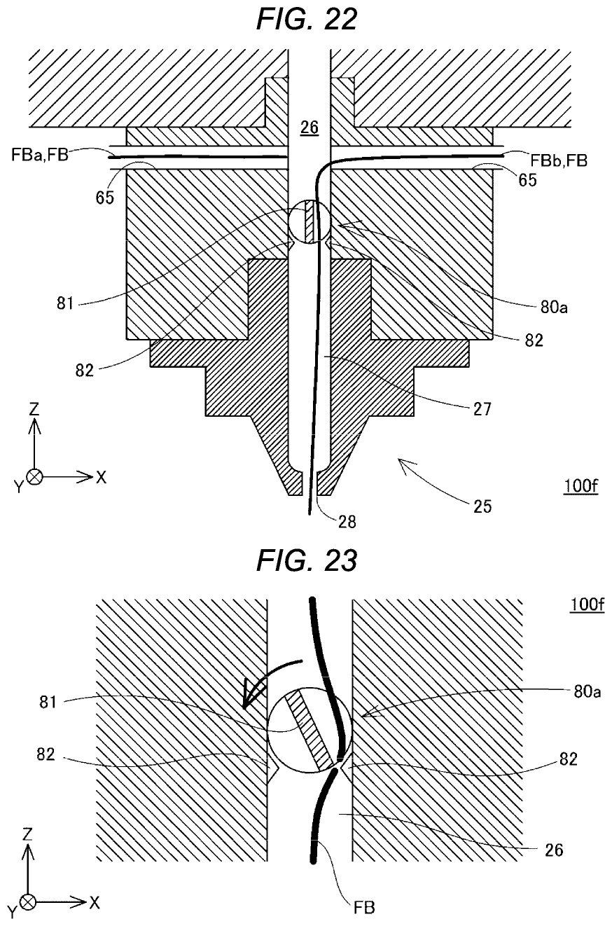

FIG. 23 is a schematic diagram illustrating a mechanism in which the discharge amount control mechanism 80a cuts the fiber material FB. FIG. 23 schematically illustrates how the butterfly valve 81 of the discharge amount control mechanism 80a rotates to cut the fiber material FB from the state illustrated in FIG. 22. When the butterfly valve 81 rotates to close the introduction flow path 26, the fiber material FB, which is inserted through the flow path between the butterfly valve 81 and an internal wall surface of the nozzle flow path 27, is sandwiched between an end portion of the butterfly valve 81 during rotation and the cutter blade 82, and pressed against and cut by the cutter blade 82. After the fiber material FB is cut, the butterfly valve 81 continues to rotate and closes the nozzle flow path 27.

In the shaping apparatus 100f according to the eighth embodiment, a shaping processing is executed by the steps illustrated in FIG. 8 described in the first embodiment. In the shaping processing, the control unit 10 controls the motor 88 to drive and controls the gear unit 89 to switch the transmission destination of the driving force generated by the motor 88. When the fiber material FB selected in the selection step of step P20 is introduced into the plasticized material in the generation step in step P50, the control unit 10 transmits the driving force generated by the motor 88 to the conveying unit 60 with the gear unit 89 and uses the driving force to convey the fiber material FB. When starting discharge of the shaping material from the nozzle opening 28 in step P70, in order to adjust the discharge amount, the control unit 10 temporarily switches the transmission destination of the driving force generated by the motor 88 to the discharge amount control mechanism 80a with the gear unit 89, and rotates the butterfly valve 81 of the discharge amount control mechanism 80a to control the discharge amount of the shaping material. In step P80, when stopping the discharge of the shaping material, the control unit 10 switches the transmission destination of the driving force generated by the motor 88 from the conveying unit 60 to the discharge amount control mechanism 80a, and rotates the butterfly valve 81. Step P80 can be interpreted as including a cutting step of cutting the fiber material FB using the discharge amount control mechanism 80a. In step P80, the introduction of the fiber material FB is stopped, the fiber material FB is cut, the nozzle flow path 27 is closed, and the discharge of the shaping material from the nozzle opening 28 is stopped.

According to the shaping apparatus 100f according to the eighth embodiment, since the conveying unit 60 and the discharge amount control mechanism 80a are driven by the common motor 88, a size of the apparatus configuration can be reduced. According to the shaping apparatus 100f according to the eighth embodiment, since the discharge amount control mechanism 80a can stop the discharge of the shaping material at the same time as cutting the fiber material FB, controllability of the discharge of the shaping material from the nozzle opening 28 is further improved.

### 9 Ninth Embodiment

FIG. 24 is a schematic diagram illustrating a configuration of a discharge amount control mechanism 80b included in a shaping apparatus 100g according to a ninth embodiment. FIG. 24 schematically illustrates a state in which a rod 83 of the discharge amount control mechanism 80b is positioned at an initial position, which will be described later, and the fiber material FB is being send to the nozzle flow path 27.

The shaping apparatus 100g according to the ninth embodiment has substantially the same configuration as the shaping apparatus 100f according to the eighth embodiment except for the following matters. The shaping apparatus 100g includes the discharge amount control mechanism 80b having a configuration different from that of the discharge amount control mechanism 80a described in the eighth embodiment. The discharge amount control mechanism 80b according to the ninth embodiment is provided in the nozzle flow path 27. The discharge amount control mechanism 80b realizes, by moving the rod 83 in a direction intersecting the nozzle flow path 27 by a plunger mechanism, a function of controlling the discharge amount of the shaping material by opening and closing the nozzle flow path 27 and a function of cutting the fiber material FB. The shaping apparatus 100g, which is not illustrated, has a butterfly valve similar to the discharge amount control mechanism 80 described in the first embodiment on upstream of the discharge amount control mechanism 80b, and can stop a discharge of the plasticized material from the nozzle opening 28 by opening and closing the butterfly valve.

The discharge amount control mechanism 80b includes the rod 83 that performs a piston motion in the direction intersecting the nozzle flow path 27, a drive mechanism 84 that drives the rod 83, a recessed portion 86 formed at the internal wall surface of the nozzle flow path 27, and the cutter blade 82 provided in the recessed portion 86. The rod 83 moves in a branch flow path 85 that is coupled to the nozzle flow path 27. Similarly to the discharge amount control mechanism 80a according to the eighth embodiment, the discharge amount control mechanism 80b according to the ninth embodiment receives a driving force of the rod 83 from the motor 88 common to the conveying unit 60 illustrated in FIG. 21. The drive mechanism 84 instantaneously moves the rod 83 by converting a rotational motion generated by the motor 88 into a linear motion.

First, a mechanism for controlling the discharge amount of the plasticized material by the discharge amount control mechanism 80b will be described. When the rod 83 is instantaneously moved to a deep position in the branch flow path 85, the plasticized material is drawn into the branch flow path 85 in accordance with the movement of the rod 83. Thus, a negative pressure is generated in the nozzle flow path 27, and the plasticized material discharged from the nozzle opening 27 is pulled back to the nozzle flow path 27, so that the discharge of the plasticized material from the nozzle opening 28 can be temporarily stopped. In contrast, when the rod 83 is moved from the deep position in the branch flow path 85 toward the nozzle flow path 27, the plasticized material in the branch flow path 85 is extruded into the nozzle flow path 27, and the discharge amount of the plasticized material can be temporarily increased. Thus, the discharge amount control mechanism 80b can control the discharge amount of the plasticized material from the nozzle opening 28 by the movement of the rod 83.

Next, a mechanism for cutting the fiber material FB by the discharge amount control mechanism 80b will be described. The rod 83 can be instantaneously moved to protrude from the branch flow path 85 into the nozzle flow path 27. A tip of the rod 83 that is protruded into the nozzle flow path 27 is received by the recessed portion 86. The fiber material FB is cut by a movement of the rod 83 of protruding toward the recessed portion 86 as described below.

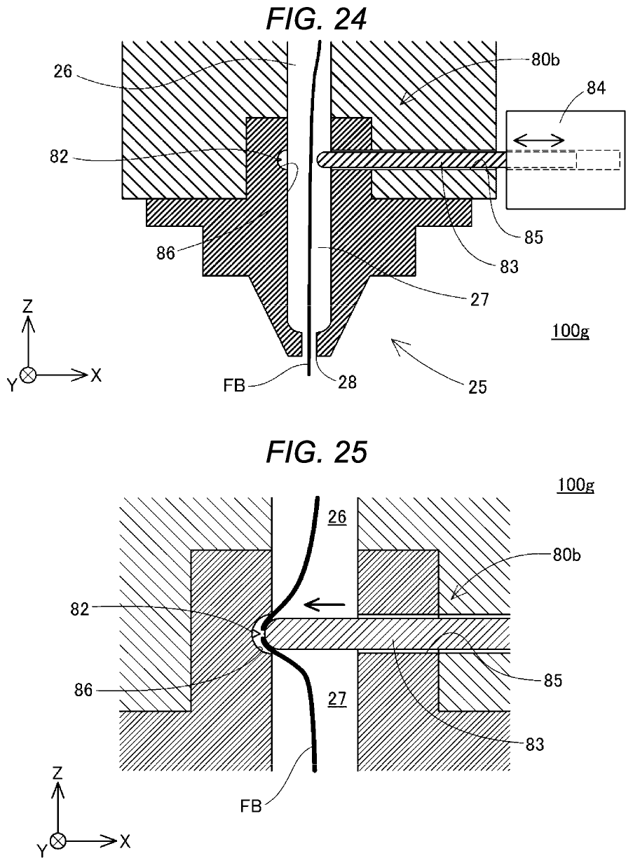

FIG. 25 is a schematic diagram illustrating a mechanism in which the discharge amount control mechanism 80b according to the ninth embodiment cuts the fiber material FB. FIG. 25 schematically illustrates how the rod 83 of the discharge amount control mechanism 80b is moved, from the state illustrated in FIG. 24, in a direction in which the rod 83 protrudes into the nozzle flow path 27 to cut the fiber material FB. As described above, the cutter blade 82 is provided in the recessed portion 86 that receives the tip of the rod 83. When the rod 83 is instantaneously moved toward the recessed portion 86, the fiber material FB is sandwiched between the tip of the rod 83 and the cutter blade 82 in the recessed portion 86, and pressed against and cut by the cutter blade 82.

When the butterfly valve provided on upstream of the control unit 10 is closed to stop the discharge of the plasticized material from the nozzle opening 28 or when the butterfly valve is opened to restart the discharge of the plasticized material, the control unit 10 of the shaping apparatus 100g drives the discharge amount control mechanism 80b as described below. While the plasticized material is discharged from the nozzle opening 28, the rod 83 of the discharge amount control mechanism 80b is located at a position where the tip of the rod 83 closes an outlet of the branch flow path 85 as illustrated in FIG. 17. Hereinafter, this position is also referred to as an “initial position”.

When the butterfly valve is closed, the control unit 10 drives the discharge amount control mechanism 80b to instantaneously move the rod 83 toward the recessed portion 86 to protrude from the initial position to the nozzle flow path 27, thereby cutting the fiber material FB. Thereafter, the negative pressure is generated in the nozzle flow path 27 by instantaneously moving the rod 83 to the deep position in the branch flow path 85 without leaving a gap therebetween. Accordingly, the plasticized material flowing out from the nozzle opening 28 is pulled back to the nozzle flow path 27, so that the excessive plasticized material can be prevented from dripping from the nozzle opening 28 in a string-like manner after the discharge of the plasticized material is stopped.

When the butterfly valve is opened to restart the discharge of the plasticized material, the control unit 10 returns the rod 83 that is located at the deep position in the branch flow path 85 to the initial position, thereby returning the plasticized material that is drawn into the branch flow path 85 to the nozzle flow path 27. Accordingly, the discharge amount of the plasticized material can be temporarily increased when the discharge of the plasticized material from the nozzle opening 28 is restarted. Therefore, the restart of the discharge of the plasticized material can be prevented from being delayed due to an insufficient amount of the plasticized material supplied to the nozzle flow path 27 when the discharge of the plasticized material is restarted.

Thus, with the discharge amount control mechanism 80b, when the discharge of the plasticized material from the nozzle opening 28 is stopped, an outflow of the plasticized material from the nozzle opening 28 can be quickly stopped while cutting the fiber material FB. When the discharge of the plasticized material from the nozzle opening 28 is restarted, the plasticized material in the branch flow path 85 is extruded by the rod 83, and the discharge amount of the plasticized material from the nozzle opening 28 can be rapidly returned to a target value. That is, with the discharge amount control mechanism 80b, a higher responsiveness of the discharging unit 20 with respect to the discharge control of the plasticized material by the control unit 10 can be attained.

As described above, according to the shaping apparatus 100g according to the ninth embodiment, similarly to the shaping apparatus 100f according to the eighth embodiment, since the conveying unit 60 and the discharge amount control mechanism 80b are driven by the common motor 88, a size of the apparatus configuration can be reduced. Further, with the discharge amount control mechanism 80b, the controllability of the discharge of the shaping material including the fiber material FB can be further improved.

### 10 Other Embodiments

The various configurations described in the above embodiments can be modified, for example, as follows. Each of other embodiments described below is positioned as an example of a mode for implementing the present disclosure, similarly to each of the embodiments described above.

### 10-1 Another Embodiment 1

The shaping apparatus 100a according to the first embodiment may include, as the plurality of types of fiber materials FB, the fiber materials FB having different fiber diameters in addition to the first fiber material FBa and the second fiber material FBb. As in the shaping apparatus 100c according to the third embodiment, the shaping apparatus 100c may include the three types of fiber materials FBa, FBb, and FBc, or may further include four or more types of fiber materials FB. When there are a large number of types of fiber materials FB, in the selection step in step P20, a map prepared in advance may be used in which the types of the fiber materials FB are uniquely determined with respect to the thickness of the shaping layer ML to be formed. Types of the constituent materials of the plurality of types of fiber materials FB may not be the same or may be different. Each embodiment other than the first embodiment can be modified in the same manner as described in the other embodiment 1.

### 10-2 Another Embodiment 2

In the selection step in step P20 in each of the above embodiments, the fiber material FB used for forming the shaping layer ML may be selected from the plurality of types of fiber materials FB according to the thickness of the shaping layer ML to be formed. In the selection step in step P20, the fiber material FB having a larger fiber diameter may be selected as the thickness of the shaping layer ML to be formed is larger. The fiber material FB having a larger fiber diameter may be selected as the thickness of the shaping layer ML to be formed is smaller. In this case, since a ratio of the fiber material FB to a volume of the shaping layer ML to be formed increases, a strength of the shaping layer ML having a small thickness can be enhanced. In the selection step in step P20, regardless of the thickness of the shaping layer ML, a map may be used in which a relation in which the types of the fiber materials FB having appropriate fiber diameters are uniquely determined with respect to the thickness of the shaping layer ML to be formed is set.

### 10-3 Another Embodiment 3

In each of the above embodiments, the continuous fiber material FB wound around the reel 62 may not be used, and a configuration may be adopted in which the fiber material FB that is finely divided is injected and introduced so as to be mixed into the shaping material before being discharged from the nozzle opening 28. In this case, the shaping apparatus may not include the cutting unit 66 that cuts the fiber material FB.

### 10-4 Another Embodiment 4

In each of the above embodiments, the fiber material FB may not be continuously introduced into the shaping material during the execution of the shaping processing, and may be intermittently introduced into the shaping material. Therefore, the shaped object to be shaped may include a portion that is formed of a shaping material including only the plasticized material into which the fiber material is not introduced.

### 10-5 Another Embodiment 5

In each of the above embodiments, instead of plasticizing the thermoplastic resin with the flat screw 40 to generate the plasticized material included in the shaping material, the plasticized material may be generated by another method. For example, the plasticized material may be generated with an in-line screw. The shaping material may not include the plasticized material, and may include a material, other than the plasticized material, that has fluidity and that can be cured after being discharged from the nozzle opening 28, and the fiber material FB.

### 10-6 Another Embodiment 6

In the above fifth embodiment, the plurality of types of fiber materials FB may be introduced into the shaping material through the common through hole 47 formed in the flat screw 40, or a plurality of through holes 47 corresponding to the plurality of types of fiber materials FB may be formed in the flat screw 40. When forming the through hole 47 for introducing the fiber material FB in the flat screw 40, at least one through hole 47 may be provided.

### 10-7 Another Embodiment 7

In the above fifth embodiment, the pressure control unit 90 may be omitted. In this case, in order to prevent the plasticized material from flowing into the conveying path 65 of the fiber material FB from the flat screw 40, for example, a configuration may be adopted in which a portion in which a gap between the through hole 47 and the fiber material FB becomes small is locally provided.

### 10-8 Another Embodiment 8

In the above sixth embodiment, at least one introduction groove 57 may be formed at the facing surface 51. Introduction paths of the plurality of types of fiber material FB may include one introduction groove 57 that is commonly used, or may include a plurality of introduction grooves 57 corresponding to the plurality of types of fiber material FB.

### 10-9 Another Embodiment 9

In the above seventh embodiment, the introduction groove 57 for introducing the fiber material FB may be formed in the flat screw 40 separately from the groove portion 42 that functions as the flow path of the plasticized material. Similar to the above other embodiment 8, at least one introduction groove 57 may be formed.

### 10-10 Another Embodiment 10

The configurations described in the above embodiments can be appropriately extracted and combined. For example, the introduction control step in step P45 in the fourth embodiment may be applied to each of the above embodiments. The through hole 47 of the flat screw 40 according to the fifth embodiment or the introduction groove according to the sixth embodiment or the seventh embodiment may be added to the shaping apparatus according to the first embodiment or other embodiments. The pressure control unit 90 according to the fifth embodiment may be applied to the conveying units 60a and 60b according to the above embodiments. In this case, the pressure control unit 90 may control pressures in the conveying paths 65 to be higher than a pressure in the flow path of the plasticized material. The configuration in which the transmission destination of the driving force of the motor 88 is switched by the gear portion 89 according to the above eighth embodiment or the above ninth embodiment, or the configuration of the discharge amount control mechanisms 80a and 80b having the function of cutting the fiber material FB may be applied to any one of the above embodiments.

### 10-11 Another Embodiment 11

The discharge amount control mechanism 80b according to the above eighth embodiment may include a shutter valve capable of closing the nozzle flow path 27 instead of the rod 83. In this case, the shutter valve is moved toward the recessed portion 86 by the drive mechanism and received by the recessed portion 86, so that the nozzle flow path 27 can be closed to stop the discharge of the plasticized material from the nozzle opening 28 while cutting the fiber material FB.

### 10-12 Another Embodiment 12

In each of the above embodiments, a method for manufacturing a three-dimensional shaped object including the following steps may be applied. The method for manufacturing a three-dimensional shaped object includes: a plasticizing step of plasticizing at least a part of a material for shaping including a first fiber material and a thermoplastic resin to generate a plasticized material to be discharged from a nozzle opening for shaping the three-dimensional shaped object; a fiber introducing step that includes a step of introducing a second fiber material longer than the first fiber material into the material for shaping or the plasticized material before being discharged from the nozzle opening, or a step of introducing the second fiber material into the plasticized material after being discharged from the nozzle opening; and a shaping step of shaping the three-dimensional shaped object that includes the first fiber material and the second fiber material. According to this manufacturing method, the first fiber material and the second fiber material having different lengths can be combined and mixed in the three-dimensional shaped object so that strengths of the first fiber material and the second fiber material in various directions are mutually reinforced. Therefore, a strength of the three-dimensional shaped object in various directions can be easily improved.

### 10-13 Another Embodiment 13

In each of the above embodiments, a method for manufacturing a three-dimensional shaped object including the following steps may be applied. The method for manufacturing a three-dimensional shaped object includes: a plasticizing step of plasticizing at least a part of a material for shaping including a thermoplastic resin to generate a plasticized material; a fiber introducing step that includes at least one of a step of introducing a covered fiber material, which is a fiber material covered with a covering material, into the plasticized material after being discharged from a nozzle opening, and a step of introducing the covered fiber material into the material for shaping or the plasticized material before being discharged from the nozzle opening; and a shaping step of shaping a three-dimensional shaped object that includes the covered fiber material. According to this manufacturing method, in the fiber introducing step, the covering material that covers a surface of the covered fiber material can prevent air bubbles from adhering to a surface of the fiber material and mixing into the plasticized material. Therefore, a decrease in strength of the three-dimensional shaped object due to the mixing of the air bubbles into the shaping material can be prevented.

### 10-14 Another Embodiment 14

In each of the above embodiments, in the selection step, the fiber material is selected with respect to the thickness of the shaping layer from the plurality of fiber materials having different fiber diameters. Accordingly, the fiber material may be selected from the plurality of fiber materials having different fiber diameters based on the discharge amount per unit time and the relative movement speed between the nozzle opening 28 and the stage 72. Since the thickness of the shaping layer is determined based on the discharge amount per unit time and the relative movement speed between the nozzle opening 28 and the stage 72, the fiber materials having appropriate fiber diameters according to the thickness of the shaping layer can be included in the shaping layer, and the strength of the three-dimensional shaped object can be increased, as in each of the above embodiments.

### 11 Overview

(1) A method for manufacturing a three-dimensional shaped object according to an aspect of the present disclosure is a method for manufacturing a three-dimensional shaped object by laminating a shaping layer. The method includes a selection step of selecting a fiber material corresponding to a thickness of the shaping layer from a plurality of types of fiber materials having different fiber diameters, and a shaping step of forming the shaping layer by discharging a shaping material that includes the fiber material selected in the selection step from a nozzle opening. According to the manufacturing method according to this aspect, the three-dimensional shaping apparatus selects fiber materials having appropriate fiber diameters according to a thickness of the shaping layer from the plurality of types of fiber materials, and introduces the selected fiber materials into the shaping layer. Therefore, the shaping layer includes the fiber materials having appropriate fiber diameters, and a strength of the three-dimensional shaped object can be enhanced. A decrease in productivity of the three-dimensional shaped object due to times and efforts required for replacing and loading the fiber materials having different fiber diameters to the three-dimensional shaping apparatus can be prevented.

(2) In the method for manufacturing a three-dimensional shaped object according to the above aspect, the plurality of types of fiber materials may include a first fiber material and a second fiber material having a fiber diameter larger than that of the first fiber material. In the selection step, the first fiber material may be selected when forming the first shaping layer, and the second fiber material may be selected when forming the second shaping layer having a thickness larger than that of the first shaping layer. According to the manufacturing method according to this aspect, since a fiber material having a large fiber diameter is introduced into the second shaping layer having a large thickness, and a fiber material having a small fiber diameter is introduced into the first shaping layer having a small thickness, it is possible to prevent occurrence of a portion in the three-dimensional shaped object whose strength is significantly low due to a difference in the thicknesses of the shaping layers.

(3) In the method for manufacturing a three-dimensional shaped object according to the above aspect, the shaping step may include an outline area forming step of forming the shaping layer included in an outline area that forms an outline of the three-dimensional shaped object, and an internal area forming step of forming the shaping layer that is included in an internal area surrounded by the outline area and that has a thickness larger than that of the shaping layer included in the outline area. In the selection step, the first fiber material may be selected when forming the shaping layer included in the outline area, and the second fiber material may be selected when forming the shaping layer included in the internal area. According to the manufacturing method according to this aspect, the outline of the three-dimensional shaped object can be more finely shaped by the shaping layer having a small thickness. Since the internal area is formed using the shaping layer having the large thickness, the internal area that does not appear in an appearance can be formed more efficiently in a short time. Further, since the fiber materials having appropriate fiber diameters are respectively introduced into the shaping layers having different thicknesses, a difference in strength between the outline area and the internal area of the three-dimensional shaped object due to a difference in thickness between the shaping layers can be prevented from increasing.

(4) In the method for manufacturing a three-dimensional shaped object according to the above aspect, a thickness of a single shaping layer included in the internal area may correspond to a sum of the thicknesses of a plurality of the shaping layers that are included and laminated in the outline area. According to the manufacturing method according to this aspect, an internal structure of the three-dimensional shaped object can be formed in a short time while shaping the outline of the three-dimensional shaped object more precisely.

(5) In the method for manufacturing a three-dimensional shaped object according to the above aspect, the shaping step may include a moving step of relatively moving a stage at which the shaping layer is formed and a nozzle unit having the nozzle opening, and an introduction control step of controlling an introduction speed, at which the fiber material selected in the selection step is introduced toward the nozzle opening, in accordance with a relative movement speed between the nozzle unit and the stage. According to the manufacturing method according to this aspect, in the shaping of the three-dimensional shaped object, it is possible to prevent a change in an amount or a state of the fiber material to be introduced into the shaping layer due to a change in the relative movement speed between the nozzle opening and the stage.

(6) In the method for manufacturing a three-dimensional shaped object according to the above aspect, the shaping step may include a plasticizing step of plasticizing at least a part of a material to generate a plasticized material, and a generation step of generating the shaping material to be discharged from the nozzle opening by introducing the fiber material selected in the selection step into the plasticized material. The plasticizing step may include, in a plasticizing apparatus that includes a flat screw that has a groove forming surface in which a groove portion is formed, a facing portion that has a facing surface facing the groove forming surface and that is formed with a communication hole communicating with the nozzle opening, and a heater that is configured to heat the flat screw or the facing portion, a step of supplying the material between the flat screw and the facing portion, and guiding the material to the communication hole while plasticizing at least a part of the material by a rotation of the flat screw and heating of the heater. According to the manufacturing method according to this aspect, a size of an apparatus for executing the plasticizing step can be reduced with the flat screw in the plasticizing step. Further, since the control of the pressure and the flow rate of the plasticized material supplied to the nozzle opening is facilitated by the rotation control of the flat screw, accuracy of discharging the shaping material can be increased, and accuracy of shaping the three-dimensional shaped object can be increased.

(7) In the method for manufacturing a three-dimensional shaped object according to the above aspect, the flat screw may have at least one through hole that is opened at the groove forming surface and that communicates with the communication hole. The generation step may include a step of generating the shaping material by introducing the fiber material selected in the selection step into the plasticized material through the through hole. According to the manufacturing method according to this aspect, the fiber material can be smoothly introduced into the communication hole of the facing portion through the through hole of the flat screw.

(8) In the method for manufacturing a three-dimensional shaped object according to the above aspect, the groove forming surface or the facing surface may have at least one introduction groove that guides the fiber material selected in the selection step from a side of the flat screw or the facing portion to the communication hole. The generation step may include a step of generating the shaping material by introducing the fiber material selected in the selection step into the plasticized material through the introduction groove. According to the manufacturing method according to this aspect, the shaping material can be efficiently generated by guiding the fiber material to the communication hole using a rotational force of the flat screw and introducing the fiber material into the plasticized material.

(9) The method for manufacturing a three-dimensional shaped object according to the above aspect may include a cutting step of cutting the fiber material by operating a discharge amount control mechanism that is provided upstream of the nozzle opening and that is configured to control a discharge amount of the shaping material. According to the manufacturing method according to this aspect, the discharge amount control mechanism can control the discharge amount of the shaping material as well as the introduction of the fiber material into the shaping material, which is efficient.

(10) In the manufacturing method according to the above aspect, the discharge amount control mechanism may be driven by the motor, and the method may include a step in which the discharge amount control mechanism transmits a driving force generated by the motor to a conveying unit of the fiber material to convey the fiber material. According to the manufacturing method according to this aspect, since the conveying unit and the discharge amount control mechanism are driven by the common motor, a size of the apparatus configuration can be reduced.

(11) A three-dimensional shaping apparatus according to another aspect of the present disclosure is a three-dimensional shaping apparatus that manufactures a three-dimensional shaped object by laminating shaping layers. The three-dimensional shaping apparatus includes a control unit that selects a fiber material corresponding to a thickness of the shaping layer to be formed from a plurality of types of fiber materials having different fiber diameters, and a discharging unit that discharges a shaping material that includes the fiber material selected by the control unit from a nozzle opening under control of the control unit. According to the three-dimensional shaping apparatus according to this aspect, the control unit selects a fiber material having an appropriate fiber diameter corresponding to the thickness of the shaping layer from the plurality of types of fiber materials, and introduces the selected fiber material into the shaping material. Therefore, the shaping layer has the fiber material having an appropriate fiber diameter, and a strength of the three-dimensional shaped object can be increased. A decrease in productivity of the three-dimensional shaped object due to times and efforts required for replacing and loading the fiber materials having different fiber diameters to the three-dimensional shaping apparatus can be prevented.

1. A manufacturing method for manufacturing a three-dimensional shaped object by laminating a shaping layer, the method comprising:
a selection step of selecting a fiber material corresponding to a thickness of the shaping layer from a plurality of types of fiber materials having different fiber diameters; and
a shaping step of forming the shaping layer by discharging a shaping material that includes the fiber material selected in the selection step from a nozzle opening.

2. The method for manufacturing a three-dimensional shaped object according to claim 1, wherein
the plurality of types of fiber materials include a first fiber material and a second fiber material having the fiber diameter larger than that of the first fiber material, and
in the selection step, the first fiber material is selected when forming a first shaping layer, and the second fiber material is selected when forming a second shaping layer having a thickness larger than that of the first shaping layer.

3. The method for manufacturing a three-dimensional shaped object according to claim 2, wherein
the shaping step includes:
an outline area forming step of forming the shaping layer included in an outline area that forms an outline of the three-dimensional shaped object; and
an internal area forming step of forming the shaping layer that is included in an internal area surrounded by the outline area and that has a thickness larger than that of the shaping layer included in the outline area, and
in the selection step, the first fiber material is selected when forming the shaping layer included in the outline area, and the second fiber material is selected when forming the shaping layer included in the internal area.

4. The method for manufacturing a three-dimensional shaped object according to claim 3, wherein
a thickness of a single shaping layer included in the internal area corresponds to a sum of the thicknesses of a plurality of the shaping layers that are included and laminated in the outline area.

5. The method for manufacturing a three-dimensional shaped object according to claim 1, wherein
the shaping step includes:
a moving step of relatively moving a stage at which the shaping layer is formed and a nozzle unit having the nozzle opening; and
an introduction control step of controlling an introduction speed, at which the fiber material selected in the selection step is introduced toward the nozzle opening, in accordance with a relative movement speed between the nozzle unit and the stage.

6. The method for manufacturing a three-dimensional shaped object according to claim 1, wherein
the shaping step includes:
a plasticizing step of plasticizing at least a part of a material to generate a plasticized material; and
a generation step of generating the shaping material to be discharged from the nozzle opening by introducing the fiber material selected in the selection step into the plasticized material, and
the plasticizing step includes, in a plasticizing apparatus that includes a flat screw that has a groove forming surface in which a groove portion is formed, a facing portion that has a facing surface facing the groove forming surface and that is formed with a communication hole communicating with the nozzle opening, and a heater that is configured to heat the flat screw or the facing portion, a step of supplying the material between the flat screw and the facing portion, and guiding the material to the communication hole while plasticizing at least a part of the material by a rotation of the flat screw and heating of the heater.

7. The method for manufacturing a three-dimensional shaped object according to claim 6, wherein
the flat screw has at least one through hole that is opened at the groove forming surface and that communicates with the communication hole, and
the generation step includes a step of generating the shaping material by introducing the fiber material selected in the selection step into the plasticized material through the through hole.

8. The method for manufacturing a three-dimensional shaped object according to claim 6, wherein
the groove forming surface or the facing surface has at least one introduction groove that guides the fiber material selected in the selection step from a side of the flat screw or the facing portion to the communication hole, and
the generation step includes a step of generating the shaping material by introducing the fiber material selected in the selection step into the plasticized material through the introduction groove.

9. The method for manufacturing a three-dimensional shaped object according to claim 1, further comprising:
a cutting step of cutting the fiber material by operating a discharge amount control mechanism that is provided upstream of the nozzle opening and that is configured to control a discharge amount of the shaping material.

10. The method for manufacturing a three-dimensional shaped object according to claim 9, wherein
the discharge amount control mechanism is driven by a motor, and
the method includes a step of transmitting a driving force generated by the motor to a conveying unit of the fiber material to convey the fiber material.

11. A three-dimensional shaping apparatus that manufactures a three-dimensional shaped object by laminating a shaping layer, the three-dimensional shaping apparatus comprising:
a control unit configured to select a fiber material corresponding to a thickness of the shaping layer to be formed from a plurality of types of fiber materials having different fiber diameters; and
a discharging unit configured to discharge a shaping material that includes the fiber material selected by the control unit from a nozzle opening under control of the control unit.
